(19) United States
(12) Patent Application Publication
(10) Pub. No.: US 2010/0150689 A1
(43) Pub. Date: Jun. 17, 2010

(54) METHOD AND SYSTEM FOR ASSEMBLING PALLETS FOR STOCK ORDERS

(76) Inventors: Paul A. Berry, New South Wales (AU); Adrian A. Grunbach, New South Wales (AU); Max F. Ferrigni, Los Angeles, CA (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(21) Appl. No.: 12/526,911

(22) PCT Filed: Feb. 15, 2008
(86) PCT No.: PCT/AU08/00207

§ 371 Date: Jan. 6, 2010

Related U.S. Application Data
(63) Continuation-in-part of application No. 11/881,158, filed on Jul. 25, 2007.

(30) Foreign Application Priority Data
Feb. 16, 2007 (AU) 2007900839

(51) Int. Cl. B65G 65/00; G06F 19/00

(52) U.S. Cl. 414/273; 414/807; 700/216

(57) ABSTRACT

A method of assembling pallets containing stock units is disclosed using a negative pick/put transfer having donor pallets 14 containing quantities of stock units and recipient pallets 20 receiving stock units. A distribution system 10 and control system 32 is provided to implement negative pick/put transfers of pallets. Also disclosed are methods and systems for sequencing the assembly of pallets by matching stock orders to create negative pick/put transfer opportunities.

### CROSS REFERENCE TO RELATED APPLICATION

This application claims the priority benefits of International Patent Application No. PCT/AU2008/000207, filed on Feb. 15, 2008, and this application is a continuation-in-part application, which claims priority from U.S. patent application Ser. No. 11/881,158, filed on Jul. 25, 2007, which are hereby incorporated herein by reference in their entirety.

### BACKGROUND OF THE INVENTION

The present invention relates generally to distribution operations and more specifically to methods of assembling pallets containing stock units to fulfil stock orders, methods of sequencing pallet assemblies, and to associated systems. The invention has been developed especially, but not exclusively, for the food and beverage market and is herein described in that context. However, it is to be appreciated that the invention is not limited to that use and can be applied to other industries. Further, the term “pallet” is used in a general sense to mean a discrete quantity of stock that is transported as a single unit and is not limited to the arrangement where the stock is located on a pallet tray, but includes other arrangements for transporting stock such as crates, boxes and the like.

Within most food and beverage markets exists a sector of customers commonly termed the route trade. These are smaller customers, such as corner stores, service stations, restaurants and the like, that order smaller amounts of products on a regular replenishment cycle. Food and beverage manufacturers service these customers with smaller delivery trucks (of up to 14 pallets or less), each truck handling a defined delivery run (route) containing a number of customer drops per route.

The distribution centres service the trucks by assembling pallets of stock units (typically provided in cases) that represent the entire collective orders (or batch) for that particular route, often termed a route load. These pallets typically include a mix of stock units.

Assembly of the mixed stock unit pallets is performed by warehouse picking operators on pallet movers, travelling within the warehouse and building mixed pallets as directed by either a load pick slip or radio frequency commands.

While this type of manual picking methodology is simple and effective, increasingly food and beverage manufacturers are looking for a faster, safer and more efficient means of performing this task.

### SUMMARY OF THE INVENTION

In a first aspect, the present invention provides a method of assembling pallets containing a plurality of stock units for use in the fulfillment of a batch of stock orders, the method comprising the steps of: providing a selected subset of the pallets required to fulfil orders in the batch of stock orders; and at least partially assembling the selected pallets by a negative pick/put transfer comprising the steps of: providing one or more of the selected pallets as donor pallets containing a quantity of one stock unit; providing one or more of the selected pallets as recipient pallets which are able to receive stock units from the one or more donor pallets; and moving a portion of the one stock unit from the one or more donor pallets onto the one or more recipient pallets.

In accordance with this method, some of the stock units are removed from at least one of the donor pallets with the remainder being utilized in the assembly of a pallet to fulfil a stock order. As such, these donor pallets are provided having stock units that are normally in excess of that required in a particular order.

In the context of the specification and as indicated above, a “negative pick/put transfer” may involve multiple individual transfers from one or more donor pallets to one or more recipient pallets. The amount of individual transfers involved in any one negative pick/put transfer is dependent on various factors as will be explained below. In a particular embodiment a negative pick/put transfer results from a “match” of order lines associated with the batch of orders, and the “class” of the match dictates the number of transfers involved in that negative pick/put transfer.

In the context of the specification, an order line represents the quantity of a stock unit required in a specified pallet. The batch of orders contain a plurality of order lines that collectively determine the makeup of pallets that are required to fulfil the batch of orders.

These donor pallets would in most instances be provided as fully loaded pallets but it will be appreciated that this is not essential to the invention. Further, typically the recipient pallets are provided as empty order pallets and are set up to receive stock units. However again it is to be appreciated that the invention is not limited to such an arrangement as the recipient pallets may be provided in a partially loaded state or even as a full pallet if it is convenient to overstock a pallet to fulfil an order.

The method of the invention with the negative pick/put transfer has substantial benefit in reducing handling of stock units in the assembly of stock order pallets. It utilizes a “negative pick” where the residual stock quantities from the donor pallet are used and a “put-to-pallet” system where empty order pallets (‘the recipient pallets”) are set up to receive stock units. These processes are combined by having these recipient pallets receive stock units removed from the donor pallets.

In one form, the combined quantity of the one stock unit in the subset of pallets is a predetermined value or is within a predetermined range. In one form that predetermined value is the quantity for a full pallet load of the one stock unit or a multiple of that quantity. That multiple is typically equal to the number of donor pallets in the negative pick/put transfer (except for the case of an overstocked recipient pallet where the multiple would be the number of donor pallets plus the number of overstocked recipient pallets). In one form, the predetermined range involves quantities that are close to the predetermined value. For example, in an overstocked recipient pallet there will be additional stock units (by a few stock units). Further, the process may still be advantageous even if some manual picking is required after a negative pick/put transfer. Therefore it may be acceptable if the range is marginally less or greater than the predetermined value. In one form, the range is within ±20% of the predetermined value.

Typically the stock order pallets are assembled as part of a batch of orders that require many more pallets than a single selected subset of pallets for a particular negative pick/put transfer. In one form, to fulfil the stock orders, multiple negative pick transfers are conducted over multiple subsets of pallets. Further in at least one form, these negative pick transfers may involve different stock units.

In many instances these negative pick transfers may be independent of each other (i.e. a particular subset of pallets does not overlap with any other subset). However, in one form at least one of the selected pallets is also involved in a second negative pick/put transfer. In one form, the second negative pick/put transfer is conducted together with the first negative pick/put transfer. In a particular form, the second negative pick/put transfer involves a second stock unit. In one form, a pallet involved in two negative pick/put transfers is a donor pallet for one negative pick/put transfer and a recipient pallet for the other negative pick/put transfer.

In one form, the methods described above are used in picking operations where the stock units are moved manually. The ability to be able to limit the handling of stock units can substantially improve the efficiency of these operations as it can both reduce the total weight lifted by operators over a given time, whilst at the same time providing an opportunity to increase the total throughput of stock units.

In one form, at least one of the donor or recipient pallets are provided by a conveyor into a work area where each negative pick/put transfer occurs. In a particular form, both the donor and recipient pallets are provide on separate conveyor lines. These conveyors pass through one or more work areas where the negative pick/put transfers are conducted.

In a particular form, each negative pick/put transfer is carried out in response to instructions issued from a control system. In one form, the control system is arranged to issue instructions to operators involved in manual picking by any one or more of paper pick slips, voice commands and/or by indicators. In one form, instructions are issued to conveyors to allow indexing of pallets into work areas where the transfers occur. In yet another form, the picking operations may be automated and in one form instructions may be provided to automated picking equipment, such as a robot by the control system. In one form, the control system comprises a computing system.

In a further aspect, the invention is directed to sequencing of the assembly of pallets to allow for the negative pick/put transfers in any form described above. Further this sequencing is designed to optimise the advantages that can be derived from a negative pick/put transfer.

In one form, there is provided a method of sequencing an assembly of pallets having a plurality of stock units for use in the fulfillment of a batch of stock orders, the method comprising the steps of: identifying one or more matches between pallets required to fulfil orders in the batch of orders where a said match enables at least partial assembly of the pallets in the match by a negative pick/put transfer as described above; and sequencing the assembly of pallets utilizing those matches.

In one form, the sequence methodology comprises the step of sequencing the assembly of pallets so that the matched pallets in at least one of the identified matches are able to be at least partially assembled together.

As indicated above, the batch of orders typically contain order lines, and to establish matches to allow for negative pick/put transfers it is possible to focus on establishing matches between order lines. By doing so, it is possible to identify the stock unit to be the subject of the transfers, the destination pallets involved (as a pallet is associated with each order line) and the quantities involved in the matched order lines.

In one form, the method of sequencing may be implemented under control of a control system which may comprise an appropriately programmed computing system.

Accordingly, in a further form, there is provided a method of sequencing the assembly of pallets having a plurality of stock units for use in the fulfillment of a batch of stock orders, the orders containing order lines that represent the quantities of individual stock units required in specified pallets to fulfil the batch of orders, the method comprising the steps of: identifying one or more matches of the order lines for a first stock unit where the combined quantity of the first stock unit in each match is equal to a predetermined value or is within a predetermined range; and sequencing the assembly of pallets utilizing those matches.

In one form the method further comprises the step of sequencing the assembly of pallets so that the pallets associated with at least one of the matches of order lines are at least partially assembled together. In this way the matched pallets are able to have the first stock unit loaded by a negative pick/put transfer.

In a particular form a match of order lines also involves assigning a status to each pallet associated with the order lines in that match as being either a donor pallet or a recipient pallet (for the subsequent negative pick/put transfer).

In one form the predetermined value is the quantity for a full pallet load of the one stock unit or a multiple of that quantity. That multiple is typically equal to the number of donor pallets in the negative pick/put transfer (except for the case of an overstocked recipient pallet where the multiple would be the number of donor pallets plus the number of overstocked recipient pallets). In one form, the predetermined range involves quantities that are close to the predetermined value. For example, in an overstocked recipient pallet there will be additional stock units (by a few stock units). Further, it may still be advantageous if some manual picking is required after a negative pick/put transfer. Therefore it may be acceptable if the range is marginally less or greater than the predetermined value. In one form, the range is within ±20% of the predetermined value.

In establishing the “matches” of order lines various criteria may be used. In a particular form, the matching of order lines has regard to the efficiency of a negative pick/put transfer that would result from that match. For example the efficiency may be improved by increasing the opportunities to use the negative picks. However, to avoid inefficient handling of the stock, the increase of negative picks needs to be achieved without significantly increasing the need to remove stock units from the donor pallets which are then not used on the recipient pallets. The best efficiency will be achieved by minimising the number of stock units that require handling. It is clear from above that this will correspond to maximising the number and size of the negative picks, while minimising the number and size of the puts. It is also desirable, though not essential, to minimise the number of transfers. Using a trivial example involving one full donor pallet, one empty recipient pallet and one transfer, it is much better to put “0.2” and negative pick “0.8” than the other way around. Another trivial example involving two full donor pallets and two empty recipient pallets, could be organised in two ways, one involving three transfers and the other just two transfers:
0.7→0.2 0.8→0.2
+→0.1 0.7→0.3
0.8→0.2

To allow better efficiency in the assembly process, an assessment may be made of the efficiency of possible matches and then matches are identified and selected for use in the process based on this analysis. This analysis may be achieved by algorithms that are processed by a computing device.

In one form, average class efficiency factors are established for different classes of matches of order lines, each class representing a match having a unique combination of donor and recipient pallets. In a particular form the matches are selected from the possible matches within the order lines using the class efficiency factors.

In one form, the matches are selected by a process where matches that fall into a first class are identified and then selected then subsequent selections are made on the remaining pallets using other classes of matches that have lower efficiencies than the first class. This process allows for the most efficient matches to be selected first.

In another form, the analysis is run on the order lines to establish matches across all classes, but in a multi-pass manner allowing progressively lower efficiency factors, which for convenience is given the term “layered”. For example, find the matches across all classes which have an efficiency of >90%, then >80%, then >70% and so on.

In a particular form, a recursive matching algorithm is used to make the analysis in any form above and to select the matches.

In one form, the analysis may be conducted solely for one stock unit. Typically this stock unit would be the most popular stock unit in the batch.

In another form, the analysis is performed for a plurality of stock units so that a plurality of matches is established for a plurality of stock units. In one form, this is achieved by selecting the matches for a first stock unit (typically the most popular stock unit in the batch) and then conducting the analysis on one or more subsequent stock units.

If the analysis is conducted over multiple stock units, then conflicts may exist in the selected matches where one match (typically for one stock unit) cannot occur if another match proceeds because of sequencing problems and the like. Therefore it is necessary to resolve these possible conflicts as part of a sequencing of the assembly.

In one form, once the matches are established (over one or more stock units) they may be placed in groupings (where the associated pallets of the matched order lines in each group are at least partially assembled together) so that the final sequence of assembly may be established. In establishing the groupings some matches may be regarded as “dependent” where two or more matches share a common donor or recipient pallet (otherwise referred to as an “overlapping” match). In this regard and as indicated above, a pallet involved in at least one of the negative pick/put transfers may be both a donor pallet and a recipient pallet.

The existence of “dependent” matches occurs primarily when the matches of order lines have run over multiple stock units. Whilst dealing with “dependent” matches complicates the process, it can provide for more matches in a batch and therefore significantly increase the efficiency of the process.

In one form, in establishing the groupings, groupings of matches which are dependent are identified from other groups containing “independent matches” (i.e. those matches which do not involve a pallet used in any other match). These groups may then be sequenced so that they can then form part of the assembly process in conjunction with the groups of “independent” matches. In one form, identification of the groups of dependent matches is done using a matrix based process. In a particular form, a bandwidth minimisation algorithm is employed in establishing the groups of dependent matches. Bandwidth minimisation is a process used in finite element analysis to optimise node numbering so as to minimise the “connectivity distance” between adjacent finite element nodes.

In one form, the sequencing, analysis and matching may be implemented by a control system which may comprise an appropriately programmed computing system.

The sequencing of that pallet assembly typically has regard to the required departure time of orders in the batch. In one form, the original batch of orders may be separated into subgroups based on departure time (say for example a morning group and an afternoon group) and the matches are identified in each subgroup independently of the other. In another form, the batch of orders (say for a whole day) are not separated into subgroups so are not defined by departure times. The benefit of this approach is that a larger batch of orders may produce more efficient matches that a smaller group. To cater for departure times in the sequencing of the assembly, it may be possible to create buffers where pallets are assembled in advance and temporarily stored, and/or to introduce a further rule to take account of departure time issues and the final selected matches are decided utilizing this rule.

In yet a further aspect, the invention provides a method of fulfilling a batch of stock orders comprising the steps of: sequencing the assembly of pallets by a method according to any form described above; and assembling pallets in accordance with any form described above using one or more negative pick/put transfers, whereby associated pallets of each matched order line comprising a selected subset of pallets for a negative pick/put transfer and the stock unit of that matched order line is the one stock unit transferred.

The assembly method, sequencing and fulfillment processes described in any form above has particular application where the required quantity of a few stock units in an order is substantially greater than the required quantities of other stock units. For instance, food and beverage manufacturers produce a range of stock keeping units (SKUs) covering many brands, flavours and sizes. However, orders consistently require many cases of the fastest moving SKUs, often at or above an 80/20 volume to SKU profile. In these circumstances, the fast moving SKUs may be the stock units of the above described methods for matches that are first identified for the negative pick/put transfers.

In yet a further aspect, the invention provides a distribution system comprising a work area for receiving at any one time, one or more donor pallets each containing a quantity of a stock unit and one or more recipient pallets arranged to receive stock units; and a control system operative to control the transfer of the stock units from the donor pallets to the recipient pallets so as to establish desired quantities of the stock units in the donor and recipient pallets for use in the fulfillment of stock orders.

In one form the control system is arranged to issue instructions to control the transfer. The control system may be arranged to issue these instructions in any suitable form. In one form, the control system is arranged to issue instructions to operators involved in manual picking by any one or more of paper pick slips, voice commands and/or by indicators. In one form, instructions are issued to conveyors to allow indexing of pallets into work areas where the transfers occur. In yet another form, the picking operations may be automated and in one form instructions are provided to automated picking equipment such as a robot by the control system. In one form, the control system comprises a computing system.

In one form, the control system is arranged to implement the sequence methodology discussed with reference to the earlier aspects of the invention.

In yet a further aspect the invention provides a control system for use in the above methods and distribution system. In a particular form, the control system comprises a computing system appropriately programmed for use in the above methods and distribution system.

### BRIEF DESCRIPTION OF THE DRAWINGS

The attached drawings show example embodiments of the invention. The particularity of those drawings and the associated description does not supersede the generality of the preceding broad description of the invention.

In the drawings:

FIG. 1 is a schematic view of a distribution centre for assembling pallets;

FIG. 2 illustrates batched orders over ten route trucks;

FIG. 3 illustrates an order sequence for assembling the pallets for the orders of FIG. 2;

FIG. 4 shows comparative results between a conventional method of pallet assembly and a method utilizing the order sequence of FIG. 3;

FIG. 5 is a schematic view of the system architecture for a control system for use in the distribution centre of FIG. 1;

FIG. 6 illustrates various examples of negative pick/put transfers in different classes of matches of order lines;

FIGS. 7 to 11 illustrate examples of various groups of order line matches and the associated negative pick/put transfers involved in assembling pallets in those groups;

FIG. 12 illustrates to layout of a work area in the distribution centre involving donor and recipient conveyors;

FIG. 13 illustrates an expanded work area of FIG. 12;

FIG. 14 illustrates the work area of FIG. 12 incorporating a recirculation conveyor;

FIG. 15 illustrates the expanded work area of FIG. 13 including a reciprocating conveyor and buffer zones;

FIG. 16 illustrates the work area of FIG. 13 incorporating a robotic arm;

FIG. 17 illustrates the associated average efficiency of various classes of matches;

FIG. 18 illustrates order lines from a batch of orders in ascending order;

FIGS. 19 to 23 illustrate matches and associated negative pick/put transfers derived from the order lines of FIG. 18 utilizing different matching algorithms;

FIG. 24 is a table of forty order lines;

FIG. 25 is a schematic representation of an expanded work area of FIG. 13; and associated output data for controlling conveyors and transfers within that work area; and

FIG. 26 illustrates the negative pick/put transfers deriving from the order lines of FIG. 24.

### DESCRIPTION OF THE PREFERRED EMBODIMENT

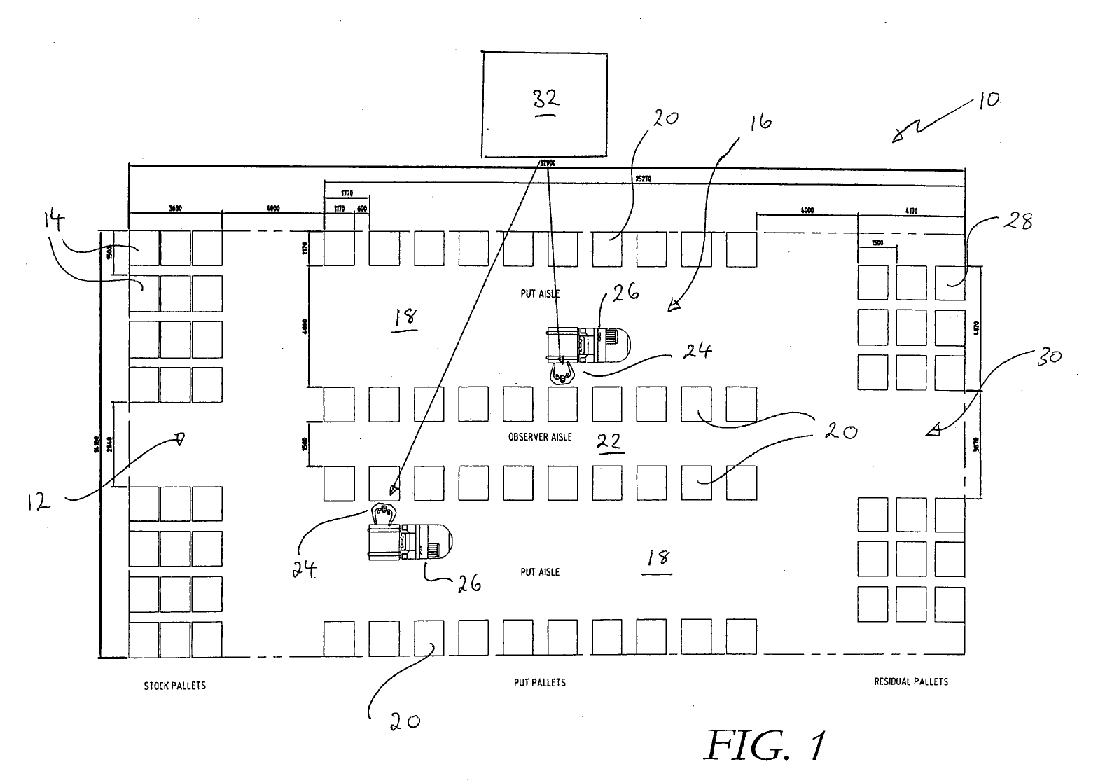

Turning firstly to FIG. 1, a work area 10 in a distribution centre is illustrated. The work area is used specifically for the manual assembling of pallets of one or more SKUs (typically the faster moving SKUs) in response to batched orders as will be explained in more detail below. In the arrangement illustrated, the work area 10 is separate from the rest of the warehouse area. As a result, the congestion and replenishment of pallets within the traditional picking areas is much reduced and operator safety greatly improved. However, it is to be appreciated that the work area may be more integrated into the remainder of the warehouse if desired.

The work area is set out so that a first area 12 contains a plurality of donor pallets in the form of fully loaded pallets 14 of the SKUs. These SKUs are typically bundled into units of cases which can be readily lifted manually. An intermediate area 16 of the work area contains two outer aisles 18 which are each bounded by two rows of recipient pallets which are in the form of empty order pallets 20. An observer aisle 22 may be located between the two inner rows of the empty order pallets 20.

Operators 24 work within the area 10 and move the loaded pallets 14 (using suitable handling equipment 26 such as fork lifts) through the aisles 18 and are arranged to off-load quantities of the SKU cases from the loaded pallets 14 onto selected ones of the empty order pallets 20. Once a required quantity of the SKU cases are off-loaded from a loaded pallet 14, that pallet (which is then referred to as a residual pallet 28) is then moved to an end 30 of the area 10. This process is referred to as a “negative pick/put” transfer as it utilizes a “negative pick” where the residual stock quantities from the donor pallet are used and a “put-to-pallet” system where empty order pallets (“the recipient pallets”) are set up to receive stock units. These processes are combined by having these recipient pallets receive stock units removed from the donor pallets.

The batched orders are typically for mixed stock and to load these other SKUs onto the pallets, the residual pallets 28 are typically moved through another part of the warehouse (not shown) along a “pick path” where these other SKUs are picked by an operator in what is commonly referred to as “ride-pick-to pallet” operation. However, it is to be appreciated that other loading techniques may be used as will be appreciated by those skilled in the art.

Similarly, when an empty order pallet 20 has received a desired quantity of the first fast moving SKU cases, it is then also removed from the intermediate area to be transported along the pick path to load up the other SKUs required to complete assembly of the mixed pallet in fulfillment of a stock order.

The negative pick/put transfer of one or more SKUs in the work area 10 involving the donor and recipient pallets (14, 20) are controlled under a control system which in this embodiment is an order management software system 32. In this particular embodiment where the transfers are conducted manually by operators 24, this system may provide commands to the operators through various mechanisms, such as voice guided picking/putting or printed pick/put slips, pick light displays etc. The voice guided picking and putting is preferred as it prompts the operator to confirm the SKU location and quantity in real time, thus increasing accuracy and reducing the need to perform checking and QA functions.

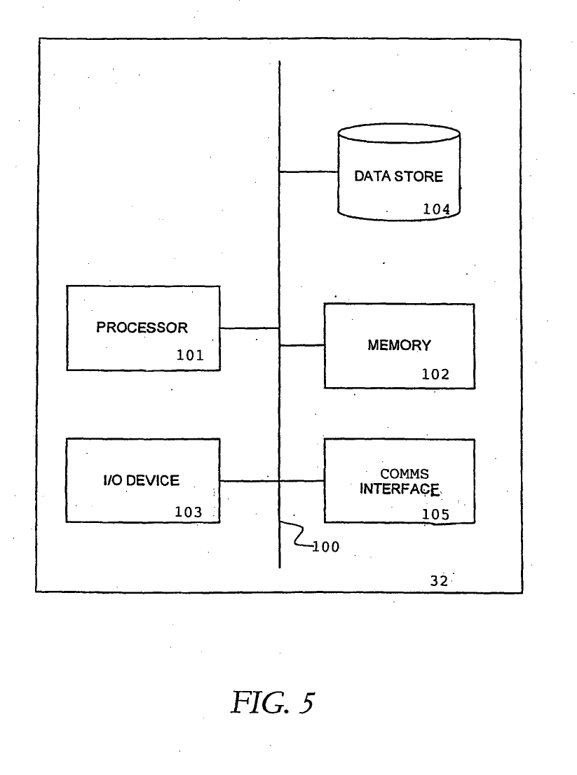

The control system 32 is, in this embodiment, implemented by a computing system. Referring to FIG. 5, an example architecture for the system 32 is illustrated. The computing system 32 comprises a bus 100 or other communication mechanism for communication between components of the computing system. The components include a processor 101 coupled to the bus 100, and a memory 102 which may be random access memory (RAM) or another volatile or non-volatile storage device for storing data and instructions to be executed by the processor 101. Memory 102 may also include a read only memory (ROM) for storing, in a non-volatile fashion, information and instructions for the processor 101.

An input/output device 103 may include a visual display unit and mouse supporting a graphical user interface, a keyboard or other input mechanism, audio output or any other output arrangement. The input/output device 103 may also include an interface for reading a computer-readable medium for providing further instructions to the computing system 32. This may include a floppy disc, a flexible disc, a hard disc magnetic tape or any other input medium.

The computing system 32 also includes a datastore, or database, 104 which may be a non-volatile read-write device such as a hard drive or flash memory, or other. A communication interface 105 is arranged to provide communications to a network and in this embodiment may provide outputs to the work area, to indictors in the assembly area for instructing puts. Alternatively, the communication interface 105 may provide outputs for controlling robotic arms for handling the puts, and/or for controlling conveyors to deliver pallets to the work area and move the pallets through the assembly area in a controlled fashion.

The computing system 32 is arranged to process sequencing, re-sequencing, matching, and to control the loading process.

It is to be appreciated that the computing system architecture is not limited to that shown and described in relation to FIG. 5, and in other embodiments different types of computer architecture may be implemented. For example, a network architecture may be utilized, for example utilizing one or more server and client computers. A mainframe type architecture may be utilized, using a mainframe computer and dumb terminals. Any appropriate architecture may be used to implement the control system 32.

In this embodiment, the computing system 32 is appropriately programmed with software to implement the sequencing and matching process. The software may take the form of program code stored or available from computer readable media, such as CD ROMS or any other machine readable media. The computer readable media may include transmission media, such as cable and/or fibre optics or any other form of transmission media.

The control system 32 is also designed to sequence the batch orders so as to improve efficiency in the order fulfillment in the work area. In particular, the system 32 aims to create optimal negative pick/put transfers. By sequencing and matching larger quantity order lines (of less than full pallet) with one, or more, smaller quantity order lines, the most effective number of negative picks can be created.

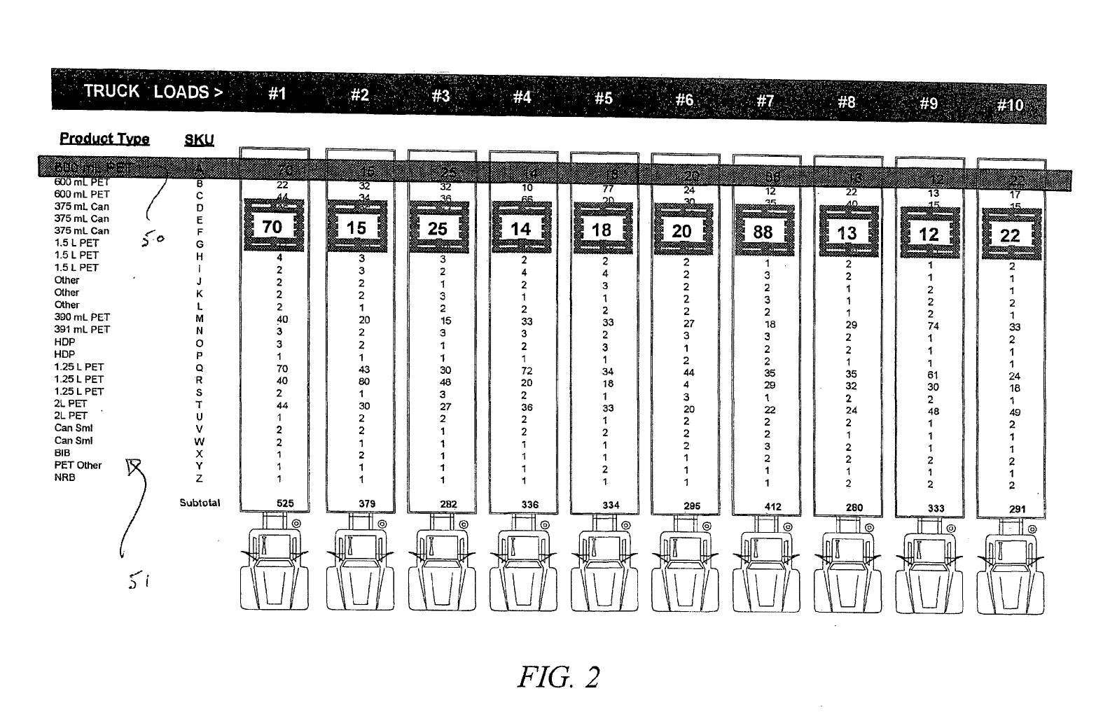

One simplified example of this re-sequencing control process is illustrated with reference to FIGS. 2 to 4. FIG. 2 illustrates order lines for batched orders across ten route trucks for mixed pallets. The shaded line highlights the consistency of a single fast moving SKUs 50 across all ten trucks, with the other products 51 listed representing less popular SKUs. The SKUs 50 are arranged to be assembled first onto the pallets in the assembly area 10, whereas the other SKUs 51 are subsequently loaded onto the pallets along the pick path, typically by the “ride-pick-to pallet” operation mentioned above. The sequence of the orders represents an initial sequence of order fulfillment of the mixed pallets based on the truck loads.

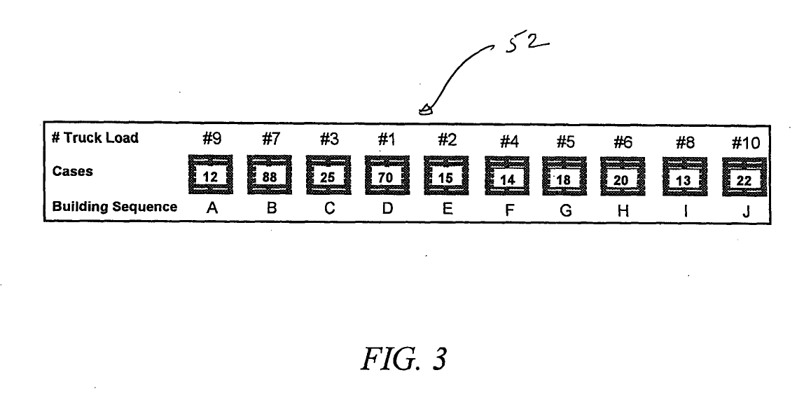

On receipt of the original batched order, the control system 32 is run and the order is re-sequenced to provide a new fulfillment sequence 52 as illustrated in FIG. 3.

In this first embodiment, the control system 32 first identifies load pallets qualifying for the work area 10 and processes them based upon despatch priority against batch allocation availability. The system 32 then optimises the putting productivity by creating “matches” of order lines, where the combined outbound orders in a match for a fast moving SKU is equal to a full SKU pallet or at least close to that quantity (say within 20% of that quantity). The largest orders complying with the criteria will be first satisfied as negative picks. The following example illustrates the grouping and negative pick priority utilized by the system, for say a 50 case SKU pallet.
1) Pair 2 order lines requiring 12 cases and 38 cases (physically handle 12, negative pick 38) and/or,
2) Pair 3 order lines requiring 10, 10 and 30 cases (physically handle two puts of 10, negative pick 30) and/or,
3) Pair 4 order lines requiring 10, 10, 15 and 15 cases (physically handle two puts of 10, one put of 15, negative pick 15) and/or,
4) Pair 4 order lines requiring 20, 20, 20 and 40 cases (physically handle one put of 20, one put of 10, negative pick 20, one put of 10, negative pick 40).

A number of additional rules, such as, time required to route destination, matching order best before dates, etc will also govern the allocation of orders to the assembly order. Some of these rules are disclosed in more detail below with respect to further embodiments of the process.

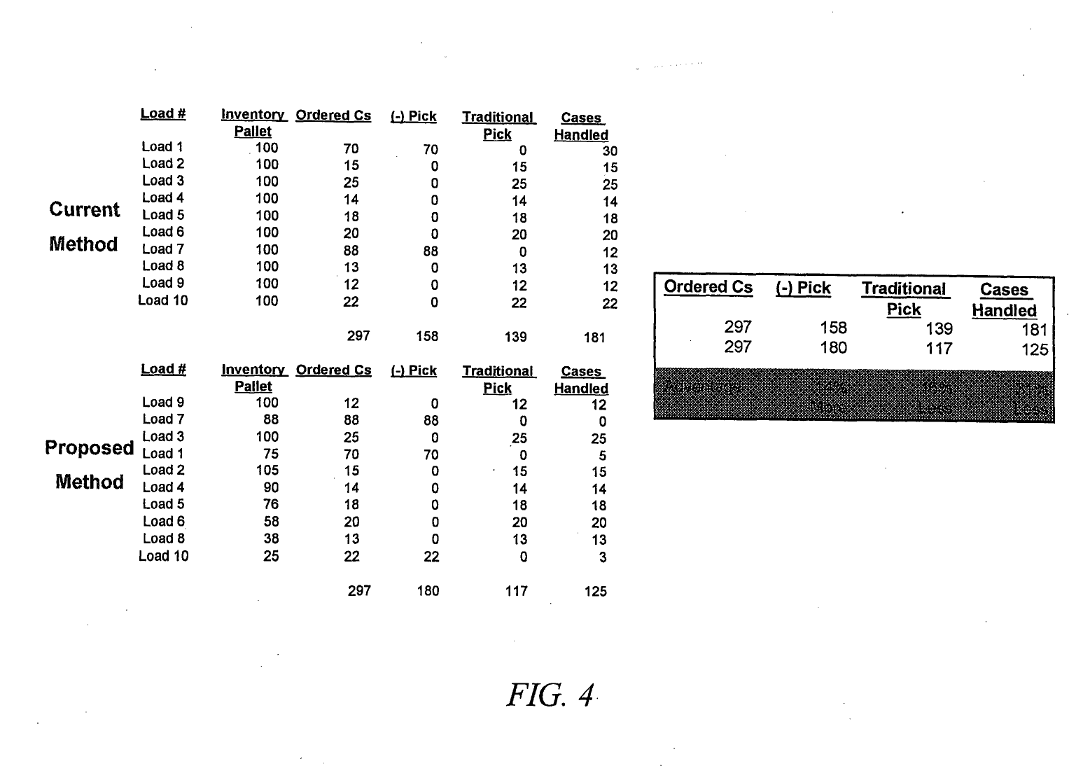

Turning to FIG. 3, this re-sequencing of the order lines allows for a more efficient outcome and a greater amount of negative picks to be achieved. This is demonstrated by the comparison chart shown in FIG. 4, which compares the original sequence shown in FIG. 2 and using a conventional “ride-pick-to pallet” operation and the re-sequenced operation shown in FIG. 3 which utilizes the assembly area 10 and a negative pick/put transfer. With this arrangement, the opportunities for “negative pick” increased by 14%, the traditional pick operations decreased by 16% which resulted in a 31% decrease in the cases handled.

In traditional ride-pick-to pallet operations, as described previously, the throughput is subject to rate limitations (of around 200-260 cases/hr) due to physical limits of operator and the pick path. The ability of operators to occasionally create negative picks (as shown above) can improve the operator pick rate and reduce the number of cases handled. Previously negative picks have been opportunistic in nature, with more experienced operators identifying negative picks when arriving at the required SKU location. When utilized with ride pick to pallet, rates of around 300-350 cases/hr can be achieved.

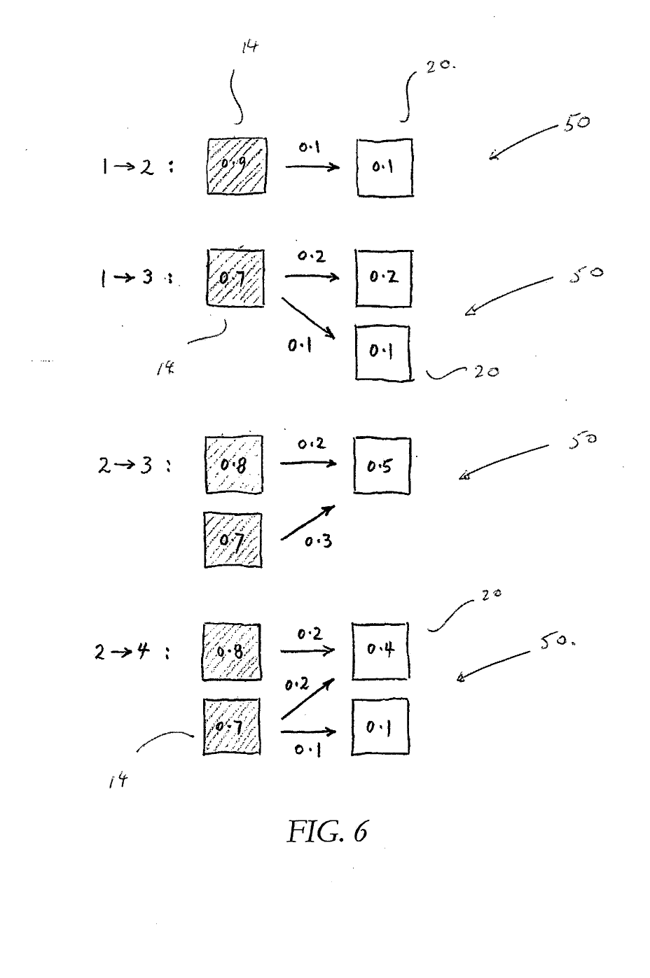

The above embodiment involves matches of order lines involving one SKU. In this arrangement, the matches may include different numbers of donor and recipient pallets and it is convenient to refer to each unique combination of donor and recipient pallets as a “class” of match. Further as the pallets typically contain different types of SKUs it is possible to create matches of the order lines for different SKUs. In some instances, matches from different SKUs may overlap in that each match may involve a common pallet. These overlapping or “dependent” matches are combined in a group so that the associated pallets can be assembled together which is desirable as it avoids the need for “double handling” the common pallet. Examples of different classes and groups of dependent matches are illustrated in FIGS. 6 to 10.

Turning to FIG. 6, four classes of independent matches 50 (i.e. matches which do not overlap with other matches) are disclosed. In the illustrated form, the shaded box represents the donor pallets 14 in the match, whereas the unshaded boxes represent the recipient pallets 20. The class of match 50 is represented by (n→m) where n=the number of donor pallets, and m=the number of final (matching) pallets. The fractions in the boxes represent the pallet load after the transfer and are represented as a fraction of a full pallet from 0.0 for an empty pallet to 1.0 for a full pallet. The → represent an individual transfer within a negative pick/put transfer of a match, and the fraction above the → symbol represents the quantity of the SKU involved in that transfer again as a fraction of a full pallet load. As seen the four classes of independent matches shown are (1→2), (1→3), (2→3), and (2→4).

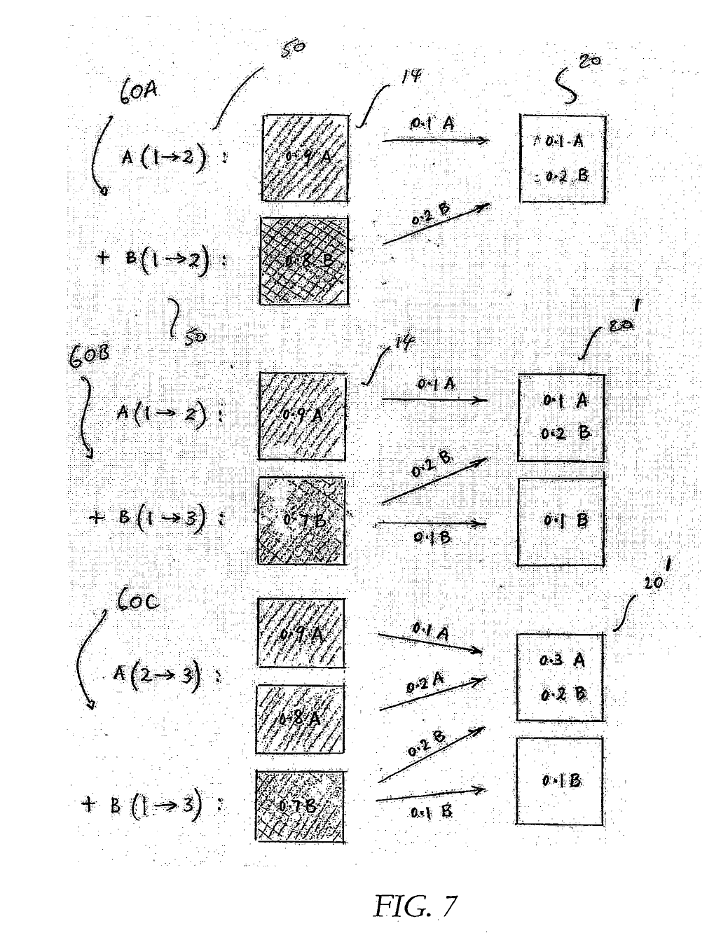

FIG. 7 illustrates three “groupings” 60 of dependent matches, where those matches involve two different SKUs (A, B) and at least one pallet that is involved in each match within its particular group. The first grouping 60A involves two matches 50 of A(1→2) and B(1→2) where the recipient pallet 20 is the common pallet. The second grouping 60B involves two matches 50 of A(1→2) and B(1→3) where one of the recipient pallets 20¹ is the common pallet, and third grouping 60C of two matches 50 of A(2→3) and B(1→3) where the recipient pallet 20¹ is the common pallet.

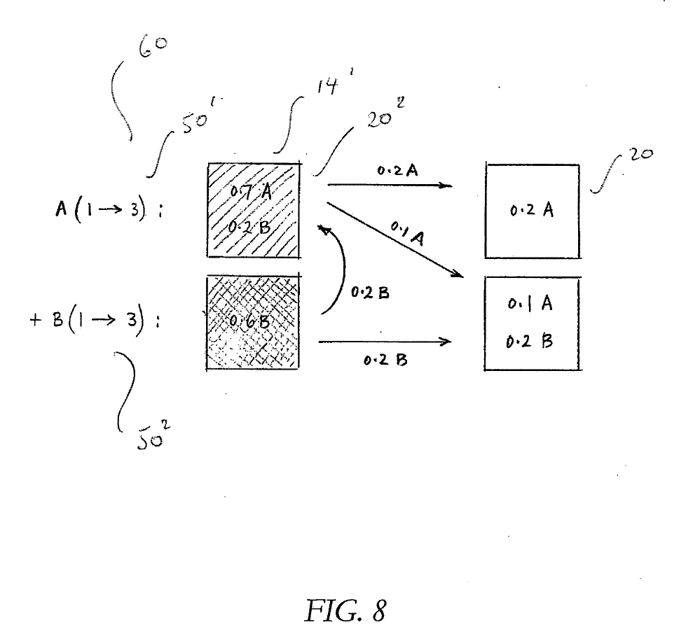

FIG. 8 illustrates another grouping 60 of two matches A(1→3) and B(1→3) where one of the donor pallets 14¹ in the first match 50¹ is one of the recipient pallets 20² in the second match 50².

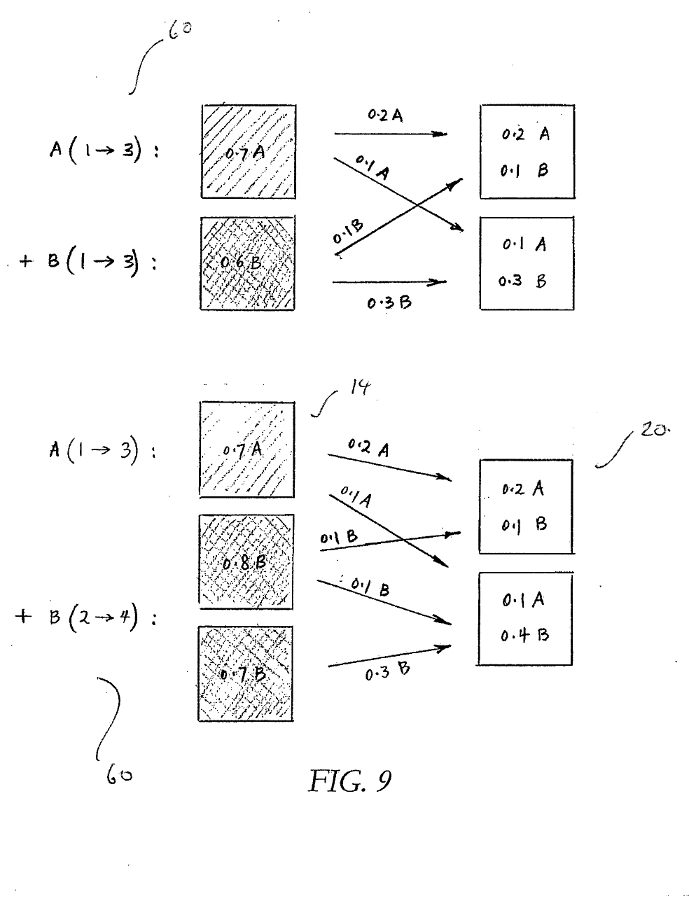

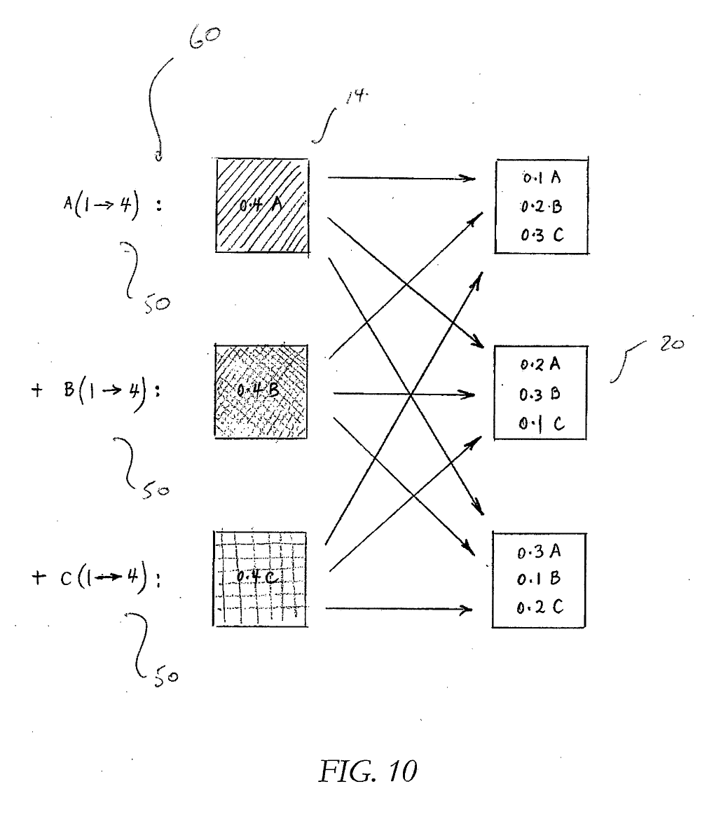

FIGS. 9 and 10 illustrate further groupings 60 of matches 50. In FIG. 9 each group involves two matches, whereas in FIG. 10, three matches involving three SKUs (A, B, C) are involved.

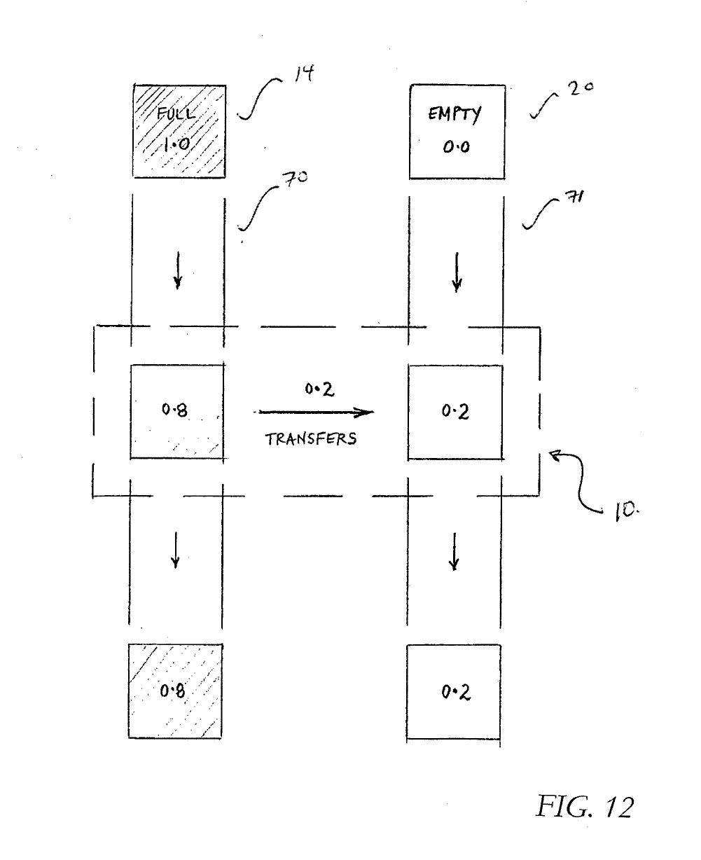

A simple arrangement of work area 10 has just one donor pallet and one recipient pallet at any instant in time. The donor and recipient pallets may be moved into the work area 10 on conveyors as shown in FIG. 12. Negative pick/put transfers that can occur on this simple layout of one donor pallet and one recipient pallet may be regarded as “sequential”. All independent matches (such as those shown in FIG. 6) may be “sequentially”. Furthermore when groupings of dependent matches are involved, the transfers can be either “sequential” or “non-sequential”. Examples of “sequential” transfers are shown in FIG. 7. Whenever the “overlap” is confined to just one common recipient pallet, the transfers can be arranged “sequentially”. It therefore follows that any combination, for which at least one of the two SKU groups involves only one put, must be “sequential”. This covers a large number of matching classes, including 4→5, 3→4, 2→3, and 1→2.

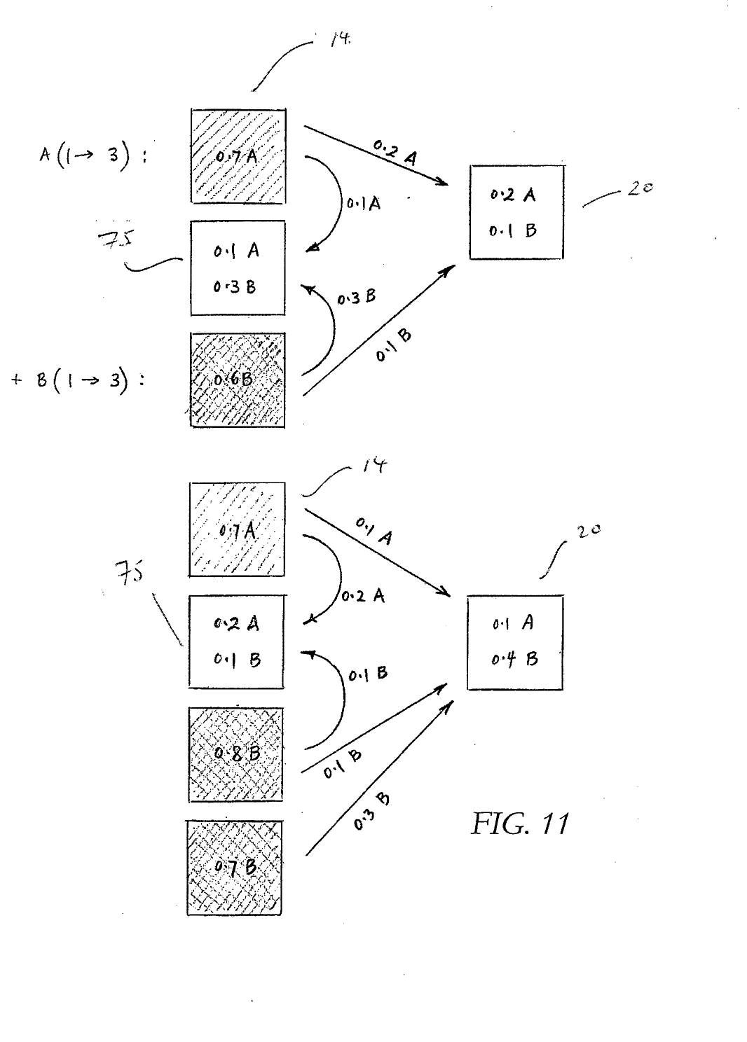

Whenever the “overlap” involves more than one common recipient pallet, as shown in FIGS. 9 and 10, the transfers from the “donor” conveyor to the “recipient” conveyor cannot be arranged in a “sequential” manner and have been termed “non-sequential”. However, by using an empty recipient pallet on the “donor” conveyor line, transfers involving just two common recipient pallets can be converted into a “sequential” arrangement. This arrangement is illustrated in FIG. 11.

A non-sequential transfer involves more complexity in the work area as it may necessitate the holding of a pallet within the work area 10 even if it is not active in a particular transfer or the reintroduction of pallets into the work area that have already been involved in a transfer. This has particular bearing on the work area 10 layout, particularly where conveyors 70, 71 are involved to move the pallets into and out of the work area 10 as will be described below with reference to FIGS. 12 to 16.

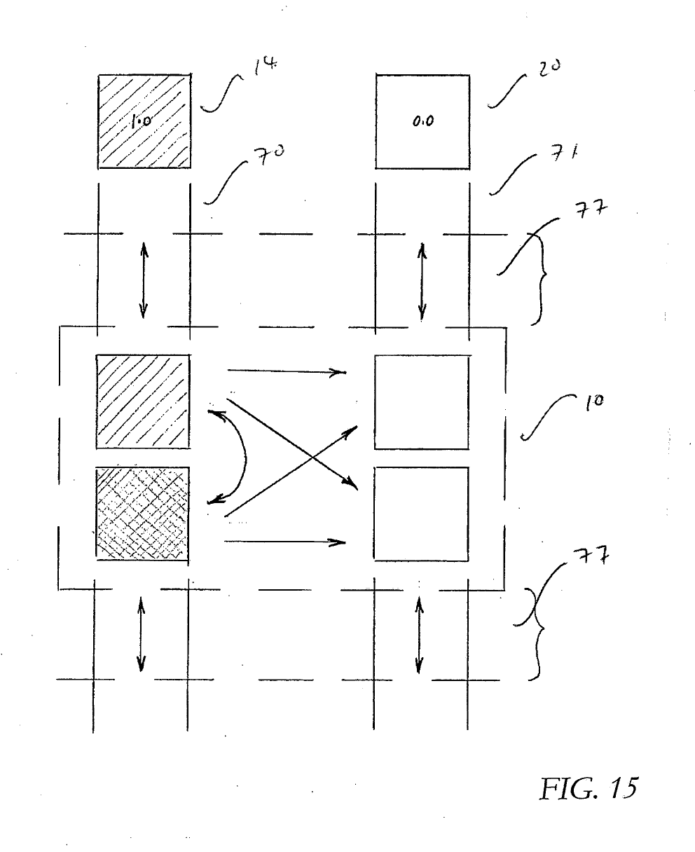

To facilitate the movement of the donor and recipient pallets (14, 20) through the work area 10, one approach is to introduce conveyors 70, and 71; one conveyor line 70 being for the donor pallets 14, the other 71 being for the recipient pallets. These conveyors may be unidirectional (as in the embodiments of FIGS. 12 to 14, or may be bi-directional as in the case of the embodiments in FIG. 15).

In the embodiment of FIG. 12 a simple layout is disclosed where the work area is restricted to two pallets (one donor, one recipient) and the conveyors 70 and 71 are unidirectional. This layout allows for the sequential transfers as discussed above. However, this simple conveyor arrangement, which uses just one donor pallet and one recipient pallet at any instant in time, does not cater for:
1. Puts to donor pallets (FIGS. 6 and 7).
2. Non-sequential transfers involving two recipient pallets (FIG. 9).
3. Empty recipient pallets on the “donor” conveyor (Page FIG. 11).

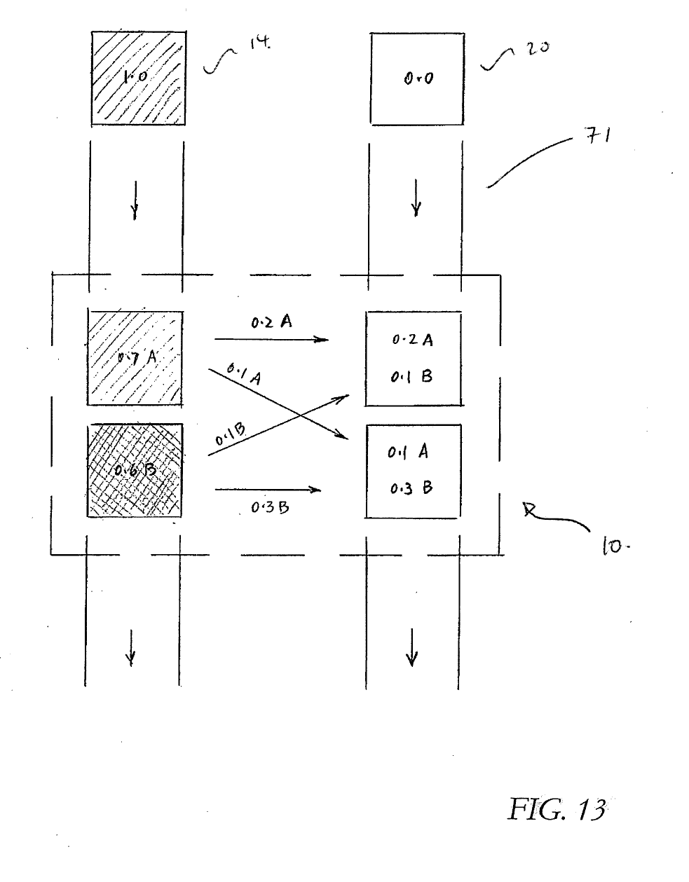

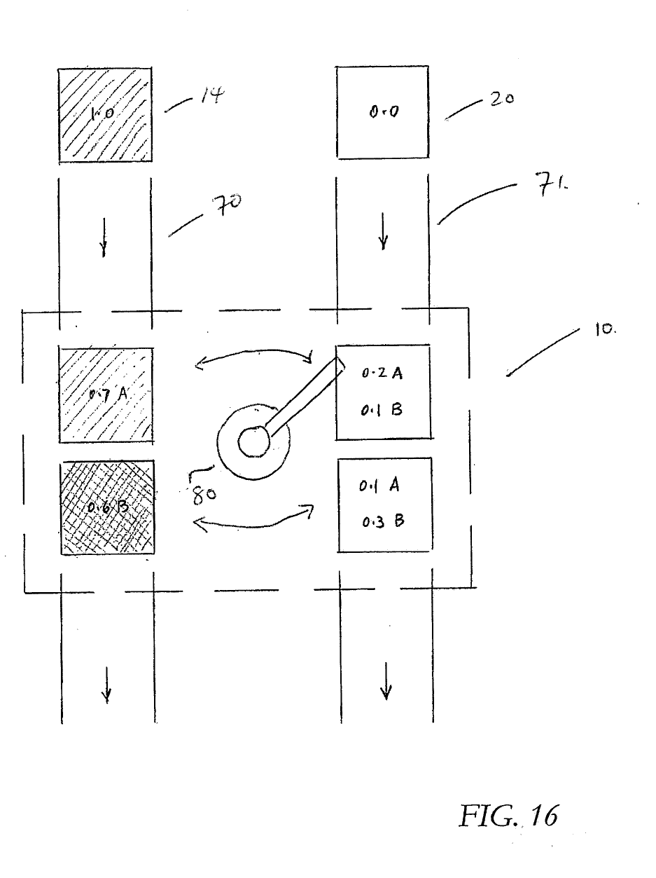

In the embodiment of FIG. 13, the work area is expanded to a 2×2 arrangement (two donor pallets and two recipient pallets in the work area at any one time). This increases the functionality of the layout considerably and can overcome the shortcomings identified above for the simple layout of FIG. 12. This arrangement permits immediate access to any of the four pallets from a central point and would have a negligible influence on the distance of transfers. This arrangement is also ideally suited for automation of the transfers using a robotic picking arm 80 as illustrated in FIG. 16.

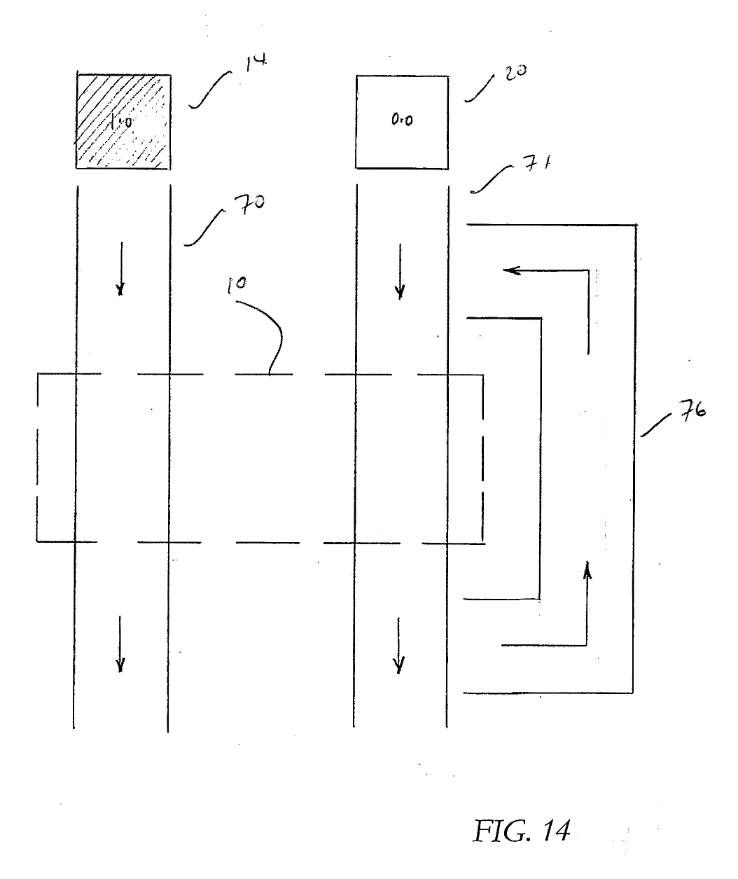

The expanded conveyor work area of FIG. 12 does not cater for the example transfers shown in FIG. 10. Three techniques can be used to overcome this problem:
1. A further expanded work area, but this would occupy more space and increase the distance of some transfers.
2. A recirculating “donor” and/or “recipient” loop, as shown in FIG. 14.
3. A reversible “donor” and/or “recipient” conveyor with a buffer zone before and after the work area to hold the pallets that are still part of the group, but are not involved in the present transfers, as shown in FIG. 15.

The above embodiments illustrate matches involving multiple SKUs that may be independent or that may be arranged in groupings of dependent matches. The following description relates to methodology for sequencing of pallets for negative pick/put transfers over multiple SKUs using matrix based algorithms to establish these matches and groupings. These algorithms are operative to be processed using a computer device (such as computing system 32 described above) for sequencing of those matches to be inputted into the control system.

The aim of the process is to take a batch of order lines and organise the order lines into the best groupings for picking efficiency utilizing negative pick/put transfers. These algorithms present a method for achieving this, which starts with the complete set of order lines in the batch of orders, and gradually sorts the order lines into groups that can be handled efficiently. As the grouping of data progresses, those order lines that can be fulfilled in a simple manner are “removed” from the remaining data. The term “removed” does not mean discarded, but rather that the solution for those order lines has been found and they no longer constitute part of the problem. They are re-integrated into the order fulfillment schedule at the end of the process.

Pallet Loads

In the context of the embodiments, a pallet is made up of cartons or cases. In order to avoid keeping track of the number of cartons that make up a full pallet, and the confusion caused by the variation of this number for different SKUs, all pallet loads are represented as a fraction of a full pallet from 0.0 for an empty pallet to 1.0 for a full pallet. Further, for ease of understanding, the algorithms are expressed in terms of pallet loads that are in the range from empty to full, which can be expressed mathematically as [0, 1]. When slightly more than a full pallet is required, rather than introduce a second pallet that would be almost empty, it is sometimes preferable to overfill the first pallet, for example by 20% (1.2). This situation is easily covered using these algorithms by matching just the additional quantity (0.2), but then arranging to “put” that quantity to a full recipient pallet (1.0), rather than the usual empty recipient pallet (0.0).

Order Lines

An order line is a component of a pallet load and is considered to contain the following minimum information, for example:
A, the SKU designation
a, the pallet load co-efficient [0, 1] of A
n, the destination pallet number

Batch

A batch is considered to be the set of order lines contributing to a total number, N, of destination pallets.

Matrix Representation

For calculation purposes, it is useful to represent the data relating to a batch of orders in matrix form, where
Columns, A, B, C, D, . . . represent the different SKU designations
Rows, 1, 2, 3, . . . , N represent the destination pallet numbers

Each element of the matrix then represents the pallet load co-efficient giving the quantity required [0, 1] of a particular SKU on a particular destination pallet. The matrix then takes the following form:

| | A | B | C | D | . . . |
|---|---|---|---|---|---|
| 1 | a₁ | b₁ | c₁ | d₁ | . . . |
| 2 | a₂ | b₂ | c₂ | d₂ | . . . |
| 3 | a₃ | b₃ | c₃ | d₃ | . . . |
| . . . | . . . | . . . | . . . | . . . | . . . |
| . . . | . . . | . . . | . . . | . . . | . . . |
| N | a_{N} | b_{N} | C_{N} | d_{N} | . . . |

where, for example
a₁, a₂, a₃, . . . , a_{N} represent the pallet load co-efficients of SKU A corresponding to the destination pallet numbers 1, 2, 3, . . . , N.

Each non-zero element of this matrix represents an order line. It should be noted that most elements will be zero, because most destination pallets will contain only a few SKUs from the full range that is available. (In matrix algebra, such a matrix with mostly zero elements is termed “sparse”.) It should also be noted that the SKU designations and pallet numbers are symbolic only and act as placeholders for the real values. Thus, for calculation purposes, it is possible to swap rows and columns of the matrix without altering the underlying data.

Assembling the Data Matrix

For any given batch:
1. Determine the parameters. Read through the order lines in the batch of orders, creating lists of the unique SKU identifiers and of the unique destination pallet locations that are required to fulfil the orders.
2. Create the matrix. Assign each SKU to the placeholders A, B, C, . . . , and each destination pallet to the numbers 1, 2, 3, . . . , N. Create a matrix of suitable dimensions and initialise each element to zero.
3. Populate the matrix. Re-read the order lines and calculate the pallet load co-efficient. This is the ratio of the required number of cartons for the given order line to the number of cartons that make up a full pallet for the particular SKU. Look up the respective placeholders for the SKU and destination pallet to find the appropriate column and row, then set that element to the pallet load co-efficient.

Trimming the Matrix

This step may be undertaken at various stages throughout the process, as the data is filtered and simplified.

For any given matrix:
1. Remove empty columns. Any column, for example SKU G, for which all elements are zero, that is g₁, g₂, g₃, . . . , g_{N} are all zero, is removed and the column placeholders are re-labelled to remain continuous.
2. Remove empty rows. Any row, for example destination pallet number 5, for which all elements are zero, that is a₅, b₅, c₅, d₅, . . . are all zero, is removed and the row placeholders are re-labelled to remain continuous.

Removing Full Pallets

Find any destination pallets, which contain a full pallet of one SKU and nothing else. That is, find any row of the matrix that has only one order line and the value of that element in the order line is 1.0. These order lines should be removed, which can be achieved by setting that element to 0.0. Once all destination pallets have been processed, the matrix should be trimmed.

Dealing with Overfull Pallet Loads

Find any destination pallets, which contain more than a full pallet of one SKU. That is, find any row of the matrix that contains a pallet load co-efficient greater than 1.0. Subtract 1.0 from this co-efficient, so that it now lies in the range [0, 1] and make a record that this order line requires a full recipient pallet rather than the usual empty recipient pallet. One way to achieve this would be to create a “shadow” recipient pallet matrix that undergoes identical transformations (swapping and removing columns and rows) as the data matrix.

Removing Low Volume SKUs

For a particular SKU to be a potential candidate for a negative pick/put transfer, the sum of order lines from the batch for this SKU should reach at least one full pallet or at least be close that quantity (say within 20% of that quantity). Any SKUs that fall below this level will need to be scheduled for normal case picking and can be removed from the current data matrix. As an example in one embodiment, any column of the matrix, for example SKU G, for which the sum of its pallet load co-efficients, given by g₁+g₂+g₃+ . . . +g_{N}, is less than 1.0 is removed and the matrix trimmed.

Maximising the Efficiency of Negative Picks

A simple measure of the efficiency of a particular negative pick/put transfer is the average negative pick co-efficient. For small independent sets, as will be shown later, it may be easier to control the first (or maximum) negative pick co-efficient.

The average negative pick coefficient may be established for different classes of matches, each class representing a negative pick/put transfer for a given SKU having a unique combination of donor and recipient pallets. Let:
n=the number of donor pallets,
   which is also equal to the number of negative picks.
p=the number of final puts.
t=the number of transfers,
   which is logically different to “p”, as shown above, and must satisfy “t>=p”.
m=the number of final (matching) pallets,
   both negative picks and puts.

Therefore,
“n+p=m”.

Since there must be at least one put, “p>=1”, it is clear that:
“n<m”.

Thus, the classes of matches can be expressed in the form:
“n→m”.
   as shown below. Each class has a different average negative picking efficiency factor. Assuming a uniform distribution of all possible theoretical outcomes, the average values can be calculated as given below:

| | | | | |
|---|---|---|---|---|
| 1 -> 2 | 1 -> 3 | 1 -> 4 | 1 -> 5 | . . . |
| (75%) | (67%) | (62.5%) | (60%) | |
| | 2 -> 3 | 2 -> 4 | 2 -> 5 | . . . |
| | (83%) | (75%) | (70%) | |
| | | 3 -> 4 | 3 -> 5 | . . . |
| | | (87.5%) | (80%) | |
| | | | 4 -> 5 | . . . |
| | | | (90%) | |
| | | | | . . . |

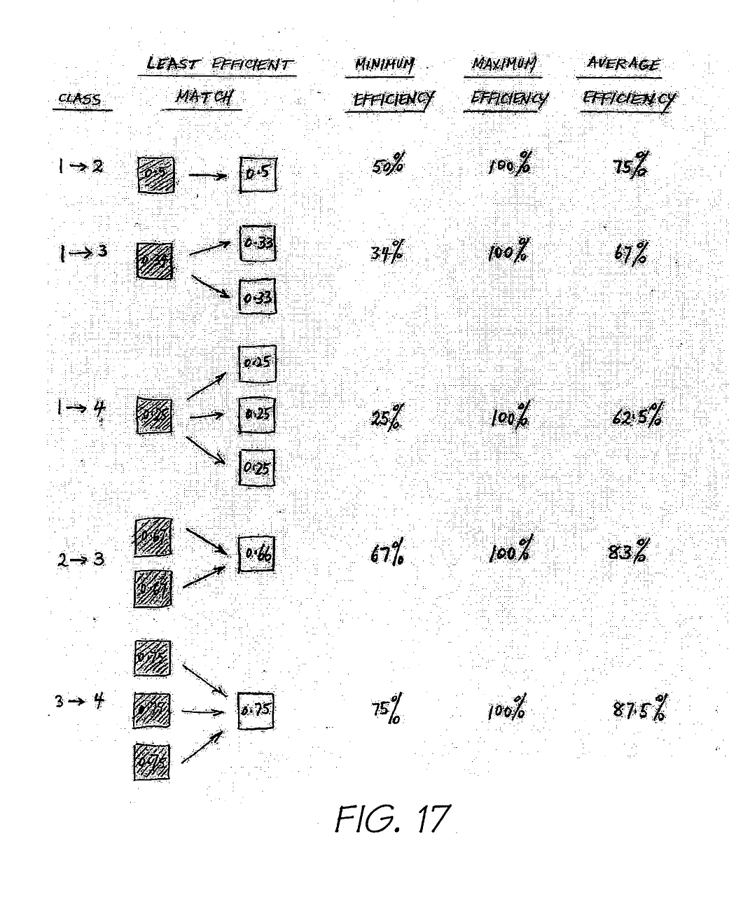

FIG. 17 illustrates various matches of different classes and the range of possible theoretical efficiencies for these classes which in turn allow for calculation of the average efficiency factor for these classes.

Optimisation of Matched Groupings

The combination of the idea of an efficiency factor and the realisation above that different classes of matches have different efficiency factors presents at least two strategic concepts that can be used either singly or in combination to optimise the selection of matches of pallets to fulfil order lines by negative pick/put transfers:
1. By class efficiency. The order lines of each SKU can be searched for matches in descending order of average efficiency of the class, starting from the most efficient class. For example, 4→5 (90%), 3→4 (87.5%), 2→3 (83%), . . . .
2. By “layered” efficiency factor. The order lines can be searched across all classes, but in a multi-pass manner allowing progressively lower efficiency factors, which for convenience is given the term “layered”. For example, find the groupings across all classes with an efficiency that is >90%, then >80%, then >70%, and so on. The aim is to prevent an order line from being used in a match with a low efficiency, when it could have been used as part of a more efficient match.

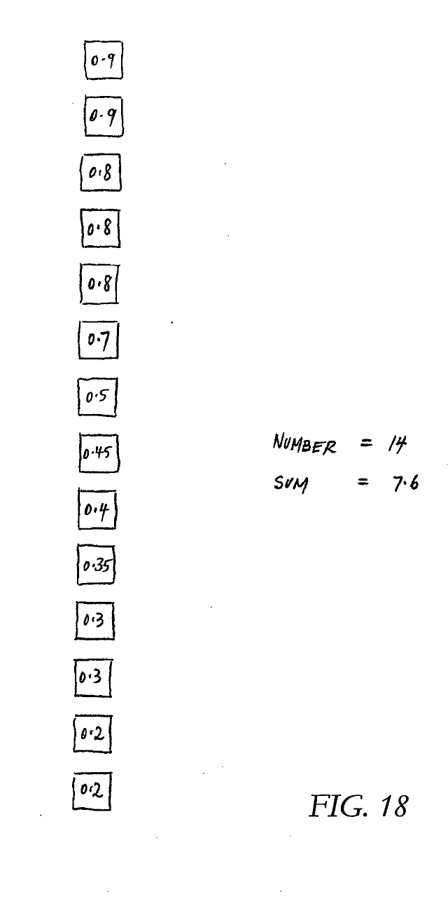

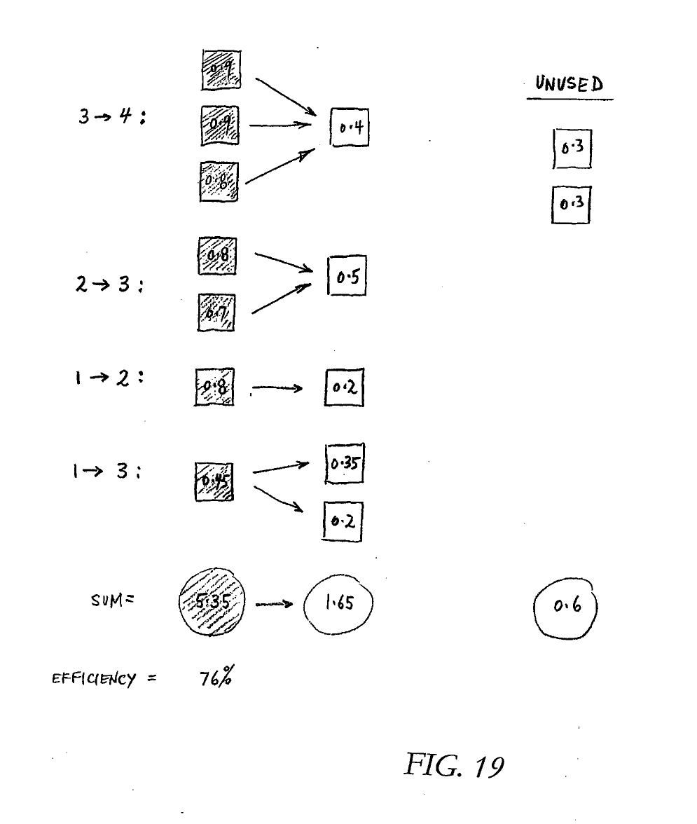

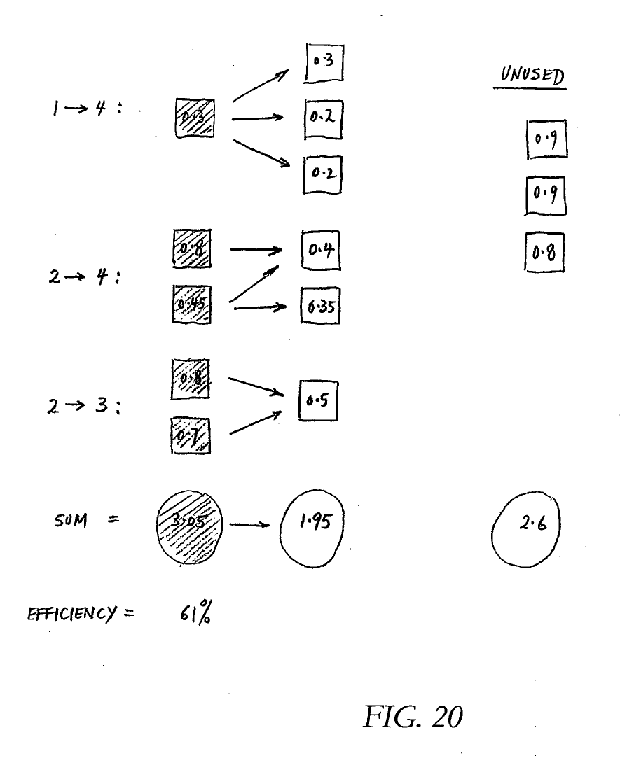

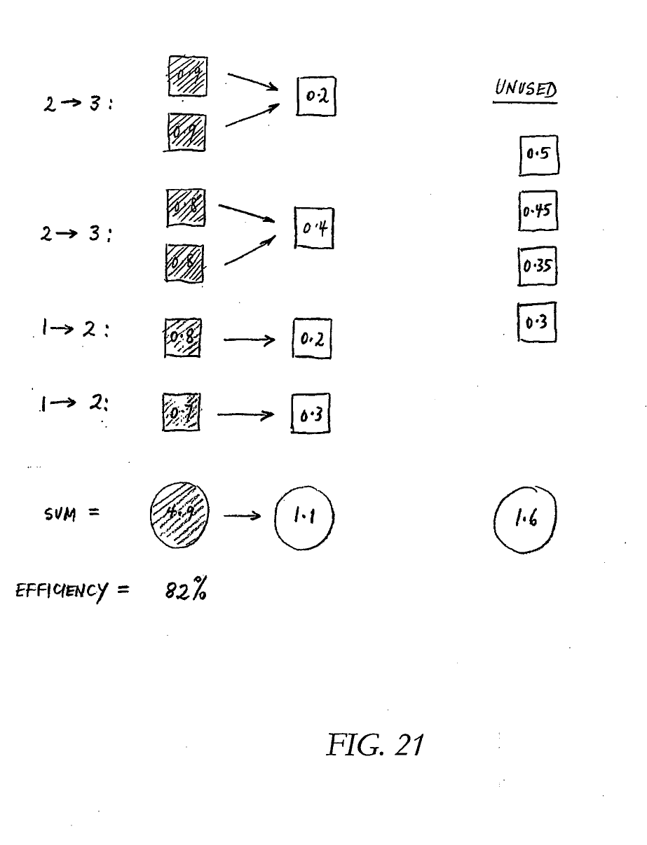

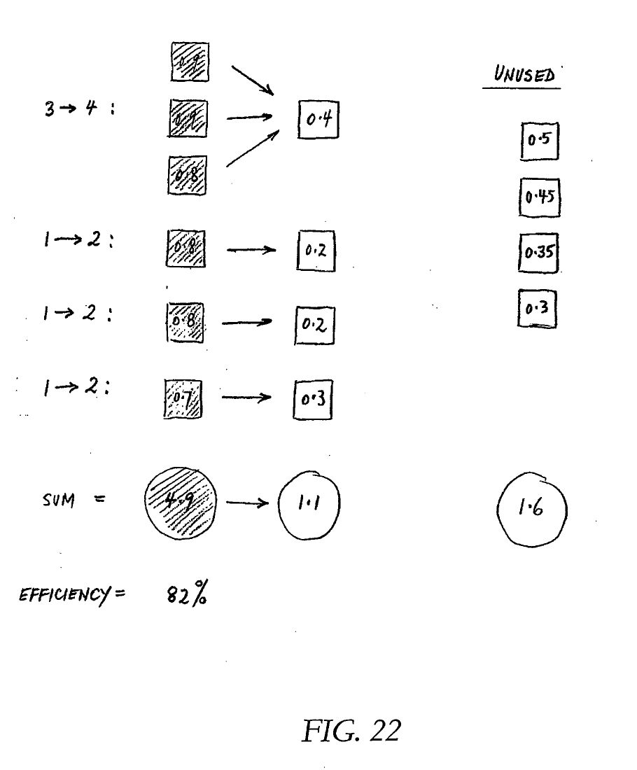

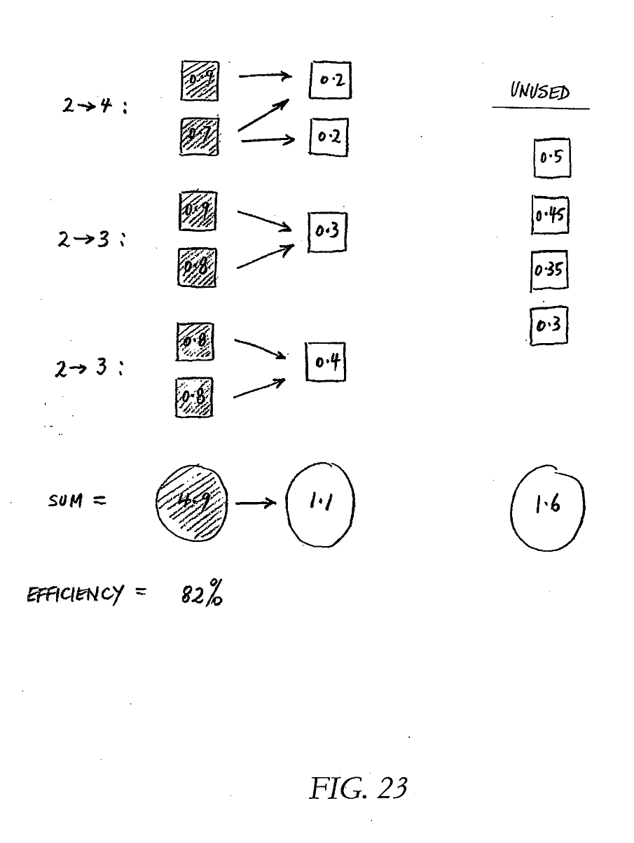

FIGS. 18 to 23 illustrate matching examples using the different techniques above. Using a batch of order lines 90 (in descending order) as shown in FIG. 18, different efficiencies can be achieved using different techniques. In FIG. 19, an efficiency of 75% is achieved using a class order matching process. By using reverse class order, the efficiency drops to 61% as shown in FIG. 20. In FIG. 21, the matches are made in class efficiency order, giving an overall efficiency of 82%. In FIGS. 22 and 23, a layered class order approach is used (in FIG. 22 it is in class order, whereas in FIG. 23 it is reverse class order) and the efficiency in both cases is 82%.

Recursive Matching Algorithm

The selection of matches may be represented and conducted recursively. Such an algorithm requires the following inputs:
m=the number of elements to be matched,
   that is, the number of final (matching) pallets, as defined above.
S=the desired sum of those matched elements.
L=the list of elements, e,
   either reduced to those elements that are still eligible,
   or with a specified starting point for sequential searching.

It should be noted that at any point it is only necessary to search all the forward elements, because if a previous element could form part of the matching group, such a match would have been found while it was being processed earlier. This technique reduces the computational effort by 50%.

Another way to minimise the computational effort is to incorporate simple tests at appropriate stages to check whether a match is still possible. For example, since each element is restricted to the range of [0, 1], no match will exist once “m<S”.

At each level, if the algorithm has been able to find a match, it returns an appropriate signal and the elements it has used in making the match. Once the algorithm has returned to the top level, all those elements are extracted from the list, and the search can commence for the next matching group.

The working of this algorithm is best explained by starting with the simplest cases and then using these as building blocks for the more complicated cases.

Class “1→2”: Match(2, S, L)

For a given SKU, for example SKU G, the aim is to find any two elements, gᵢ and gⱼ, from the list of elements g₁, g₂, g₃, . . . , g_{N} contained in column G of the data matrix, such that
“gᵢ+gⱼ=1.0”.

The recursive algorithm can be used to search for this match as follows:

First Level

m₁=2

S₁=S=1.0

L₁=L

For each element, e₁, in L₁:
Second Level
m₂=m₁−1=1
S₂=S₁−e₁=1.0−e₁
L₂=remaining list from current next element
This is now a simple search for a single element with load co-efficient=S₂

Class “2→3”: Match(3, S, L)

For a given SKU, for example SKU G, the aim is to find any three elements, gᵢ, gⱼ and gₖ, from the list of elements gᵢ, g₂, g₃, . . . , g_{N} contained in column G of the data matrix, such that
“gᵢ+gⱼ+gₖ=2.0”.

The recursive algorithm can be used to search for this match as follows:

First Level

m₁=3

Sᵢ=S=2.0

L₁=L

For each element, e₁, in L₁:
Second Level
m₂=m₁−1=2
S₂=S₁−e₁=2.0−e₁
L₂=remaining list from current next element
This can now be found by using Match (2, S₂, L₂), as demonstrated above.

Class “1→4”: Match (4, S, L)

For a given SKU, for example SKU G, the aim is to find any four elements, gᵢ, gⱼ, gₖ, and gₗ, from the list of elements g₁, g₂, g₃, . . . , g_{N} contained in column G of the data matrix, such that
“gᵢ+gⱼ+gₖ+=1.0”.

The recursive algorithm can be used to search for this match as follows:

First Level

m₁=4

S₁=S=1.0

L₁=L

For each element, e₁, in L₁:
Second Level
m₂=m₁−1=3

S₂=S₁−e₁=1.0−e₁
L₂=remaining list from current next element
This can now be found by using Match(3, S₂, L₂), as demonstrated above.

Pre-Sorting of Element Lists Before Matching

It is beneficial to sort the elements, for example g₁, g₂, g₃, . . . , g_{N}, into descending numerical order prior to matching for two reasons. Firstly the search for matches always starts with the higher co-efficients, which biases the outcome towards those matches with more efficient negative picking factors; and secondly in the case of a “layered” efficiency search, as described above, the negative picking element or elements, being larger, are encountered first, so the search can be stopped as soon as these elements fall below the set limit for the efficiency factor. This approach can significantly reduce the computational effort.

Matching for Restricted Efficiency Factors

As described above, when the list of elements has been pre-sorted into descending numerical order, the negative picking element or elements are encountered first. Two tests can be applied to restrict the efficiency factor:
1. Efficiency of first negative pick. This is simple and because it is applied at the first (top) level of the recursive algorithm, it dramatically reduces the computational effort.
2. Average negative pick efficiency. For any class of groupings, “n→m”, “n” is equal to the number of negative picks. In this case, the recursive algorithm needs to reach the “n”-th level before the average negative pick efficiency can be calculated.

For any batch of orders the recursive matching algorithm can be conducted over different SKUs to establish matches for each SKU.

Creating a Grouping Matrix

As part of finalising the sequence for pallet assembly using negative pick/put transfers of matched order lines it is beneficial to create a grouping matrix, in which to create groups of matches. The matched order lines in these groups are arranged to be assembled together. Whereas each column of the data matrix represents a different SKU, the columns of the grouping matrix are used to represent each separate match. Thus,
Columns, A, B, C, D, . . . now represent the different matches
Rows, 1, 2, 3, . . . , N still represent the destination pallet numbers

All elements of this matrix are initially set to 0.0 and the matrix is assembled during the matching process by assigning a new column placeholder to each match as it is found, whilst maintaining the same destination pallet numbers from the data matrix. For this column, each element of the match is entered at the row corresponding to its final destination pallet number. Once complete, this matrix should be trimmed.

Overlapping Matches

The algorithm places no restrictions on the independence between SKUs of matches. All matches are allowed for each SKU, regardless of whether they share common recipient pallets with other SKUs, which are referred to as “overlapping” matches. Although it may complicate the data processing, studies on sample data have shown that this can approximately double the number of available matches, making the development of a suitable sequencing algorithm and the additional computational effort very worthwhile.

Removing Independent Negative Picks and Puts

Once the grouping matrix has been assembled, it is easy to identify those matches that are independent of the other matches, because each element in the match will be the only item on its destination pallet. These matches form independent groups and can be allocated any position in the assembly schedule, so they can be removed from the grouping matrix. At the end of this stage, the grouping matrix should be trimmed. The algorithm for removing independent matches can be expressed in terms of the grouping matrix as:

For each column (e.g. Group G):
1. Find all the non-zero elements, e.g. gᵢ, gⱼ and gₖ.
2. For each of these rows, e.g. row i, j, and k:
   a. Check that they contain only one non-zero element.
3. If this is true for each row, the group is independent, and can be removed from the grouping matrix.

Sequencing of Overlapping Negative Picks and Puts

The grouping matrix now contains only matches that overlap with other matches. Although greatly reduced in size from the original data matrix, this grouping matrix will still be a sparse matrix and its elements may be randomly distributed across its columns and rows.

The aim is to determine from this grouping matrix how these overlapping matches should be assembled into dependent groups and sequenced to give the most efficient and least complicated schedule for the assembly of the pallets.

One approach is to use the technique of bandwidth minimisation, which is used in finite element analysis to optimise the node numbering so as to minimise the “connectivity distance” between adjacent finite element nodes.

Application of Bandwidth Minimisation Techniques

For the purposes of this explanation, let:
c=any given column number.
C=the total number of columns
r=any given row number.
R=the total number of rows.
e_{rc}=the element in row “r” and “column “c”.

The matrices to which this is applied in finite element analyses have some special matrix properties:
square, which means an equal number of columns and rows (“C=R”).
symmetric, which means a mirror image about the diagonal, which can be expressed as “eᵢⱼ=eⱼᵢ”.

The grouping matrix is very unlikely to be a square symmetric matrix, but it can be re-arranged into this form, as follows. Let:
[G]=the grouping matrix, most likely rectangular (“C≠R”).
[G]^{T}=the transpose of [G], which means flipping the matrix so that the column elements now run horizontally and the row elements now run vertically. That is, swap eᵢⱼ to eⱼᵢ.
[S]=the re-arranged grouping matrix,
   which is now square (“C=R”),
   and symmetric (“eᵢⱼ=eⱼᵢ”).

The parts are then assembled, as shown schematically below to obtain [S]:

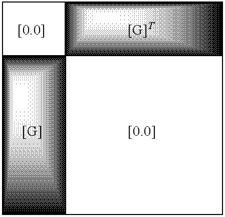

Whereas the matrix [G] has:
Columns=placeholders for the matches
Rows=placeholders for the destination pallet numbers

This new square matrix [S], now has all the placeholders represented by both the rows and the columns:
Columns=placeholders for matches and destination pallet numbers
Rows=placeholders for matches and destination pallet numbers

Using the techniques of bandwidth minimisation, the ordering of the rows and columns of this matrix can be re-arranged, so that the data is clustered about the diagonal, as shown schematically below:

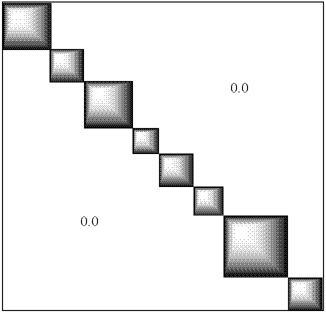

The order of the placeholders, taken from either the columns or the rows (since the matrix is symmetric), now represent the optimum sequence in which to fulfil the overlapping matches.

Optimisation of the Final Solution

The measure of the efficiency of the final solution is the total time taken to fulfil the given batch. Once the order lines have been organised into their various methods for picking, such as:
Full pallet
Negative pick
Put
Case picking
   unit times can be assigned to each step in the process for these different methods, such as:
Travel time
Handling time (per carton)
   in order to calculate an estimate of the total time required in man hours. Several final solutions can be generated using different strategies and compared using this technique to choose the optimum solution.

### Example

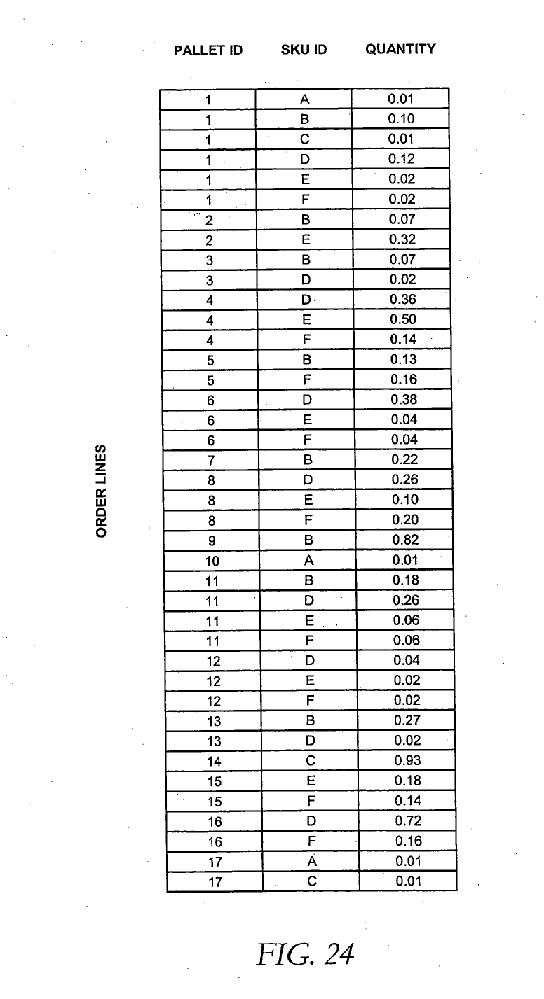

Forty order lines as shown in FIG. 24 were extracted from an order batch for sequencing. These order lines were assembled into a data matrix as follows:

$$PALLETS \begin{matrix}1 \\ 2 \\ 3 \\ 4 \\ 5 \\ 6 \\ 7 \\ 8 \\ 9 \\ 10 \\ 11 \\ 12 \\ 13 \\ 14 \\ 15 \\ 16 \\ 17\end{matrix} {{\begin{matrix}0.01 & 0.10 & 0.01 & 0.12 & 0.02 & 0.02 \\ & 0.07 & & & 0.32 & \\ & 0.07 & & 0.02 & & \\ & & & 0.36 & 0.50 & 0.14 \\ & 0.13 & & & & 0.16 \\ & & & 0.38 & 0.04 & 0.04 \\ & 0.22 & & & & \\ & & & 0.26 & 0.10 & 0.20 \\ & 0.82 & & & & \\ 0.01 & & & & & \\ & 0.18 & & 0.26 & 0.06 & 0.06 \\ & & & 0.04 & 0.02 & 0.02 \\ & 0.27 & & 0.02 & & \\ & 0.93 & & & & \\ & & & & 0.18 & 0.14 \\ & & & 0.72 & & 0.16 \\ 0.01 & & 0.01 & & & \end{matrix}}^{\begin{matrix}A & B & C & D & E & F\end{matrix}}}^{SKUS}$$

A recursive matching algorithm was applied for each SKU to the data matrix (in class order) to match the order lines. The criteria of the match was that the combined quantity of a match equalled a load pallet of [1.0] or multiple thereof for matches involving multiple donor pallets. The numbers shown in bold represent elements of the order lines that were included in the resulting matches.

These matches were then incorporated into a grouping matrix to which the bandwidth minimisation algorithm was applied. This resulted in the following grouping:

$$PALLETS \begin{matrix}1 \\ 2 \\ 3 \\ 4 \\ 5 \\ 6 \\ 7 \\ 8 \\ 9 \\ 10 \\ 11\end{matrix} { {\begin{matrix}0.72 & & & & \\ 0.26 & & & & \\ 0.02 & & & & \\ & 0.93 & & & \\ & 0.07 & & & \\ & & 0.82 & & \\ & & 0.18 & 0.26 & \\ & & & 0.38 & \\ & & & 0.36 & 0.50 \\ & & & & 0.32 \\ & & & & 0.18\end{matrix}}^{\begin{matrix}A & B & C & D & E\end{matrix}}}^{MATCHES}$$

$$EFFICIENCY \begin{matrix}0.72 & 0.93 & 0.82 & 0.38 & 0.50\end{matrix}$$

In this matrix, elements in bold represent the negative picks.

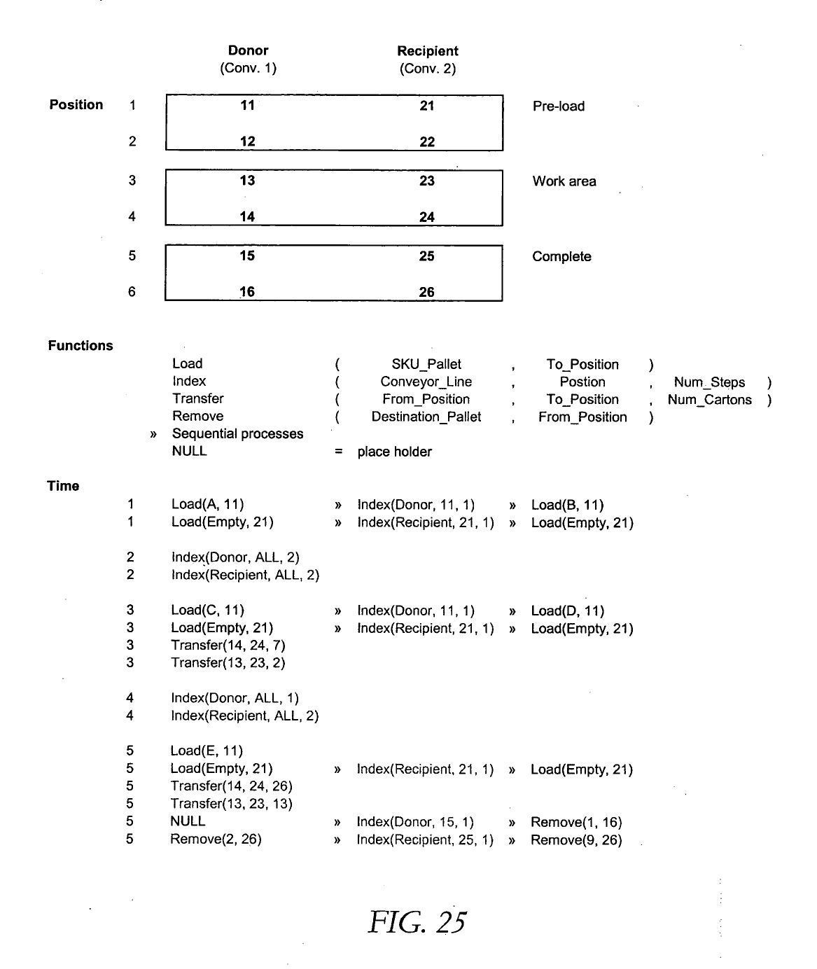

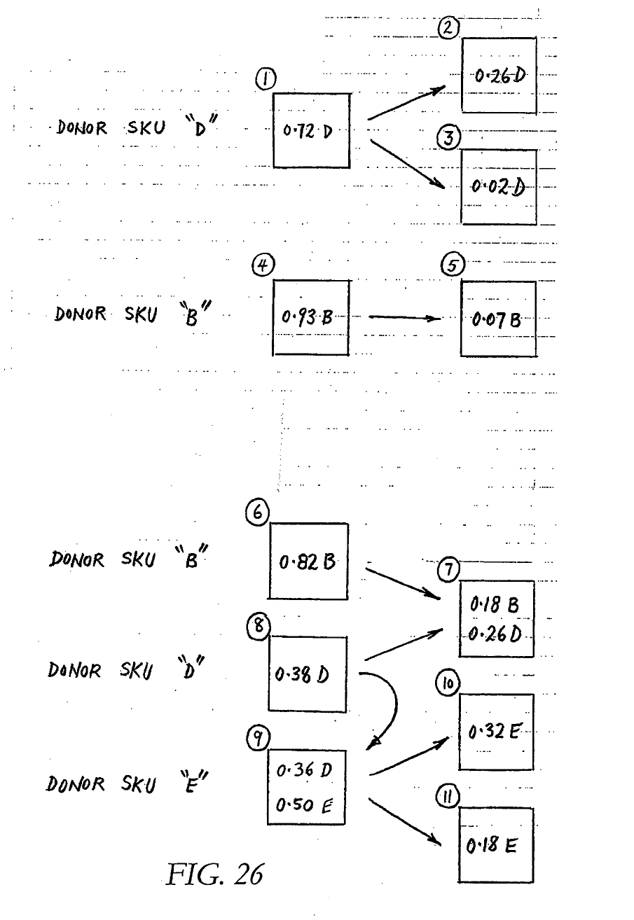

The results of the matching and grouping algorithms is then able to provide an input to the control system to issues instructions to control the negative pick/put transfers in the work area. Representative instructions to control conveyor locations in an expanded 2×2 work area and transfers within that work area (for either manual or automated transfers) are shown in FIG. 25. A schematic representation of the negative pick/put transfers resulting from the above grouping matrix is shown in FIG. 26.

Accordingly, the invention is directed to distribution systems and methods involved in the assembly of pallets and the control of that assembly and to sequencing methodology that can significantly improve the throughput of stock. The Applicant envisages that utilizing the “negative pick/put system’ disclosed under operation of a re-sequencing control system to optimise negative pick opportunities, the case handling reduction for a fast moving SKU (complying with order profile and PUT selection criteria) could be as much as 40%-67%. For manual operations, the effective throughput rates may be in the order of 1200-1715 cases/hr, an improvement of up to 490% over current ride-pick-to-pallet systems.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Variations and alterations may be made to the parts previously described without departing from the spirit or ambit of the invention.

1. A method of assembling pallets containing a plurality of stock units for use in the fulfillment of a batch of stock orders, the method comprising the steps of:
a. providing a selected subset of the pallets required to fulfil orders in the batch of stock orders; and
b. providing a control system wherein said control system issues instructions to at least partially assemble the selected pallets by a negative pick/put transfer comprising:
(i) providing one or more of the selected pallets as donor pallets containing a quantity of one stock unit;
(ii) providing one or more of the selected pallets as recipient pallets which are able to receive stock units from the one or more donor pallets; and
(iii) moving a portion of the one stock unit from the one or more donor pallets onto the one or more recipient pallets.

2. A method according to claim 1, wherein the one or more donor pallets are provided as full pallets.

3. A method according to claim 1, wherein at least some of the recipient pallets are provided as empty pallets.

4. A method according to claim 1, wherein one of the recipient pallets is loaded beyond a full pallet.

5. A method according to claim 4, wherein the recipient pallet that is loaded beyond a full pallet is provided initially as a full pallet.

6. A method according to claim 1, wherein the combined quantity of the one stock unit in the selected pallets equals a predetermined value or is within a predetermined range.

7. A method according to claim 6, wherein the predetermined value is equal to the quantity for a full pallet load of the one stock unit or a multiple of that quantity.

8. A method according to claim 7, wherein the predetermined range is ±20% of the predetermined value.

9. A method according to claim 1, wherein at least one of the selected pallets is also involved in a second negative pick/put transfer.

10. A method according to claim 9, wherein the second negative pick/put transfer is conducted together with the first negative pick/put transfer.

11. A method according to claim 10, wherein the second negative pick/put transfer involves a second stock unit.

12. A method according to claim 11, wherein a said pallet involved in two negative pick/put transfers is a donor pallet for one negative pick/put transfer and a recipient pallet for the other negative pick/put transfer.

13. (canceled)

14. A method according to claim 1, wherein the individual transfers of stock units from the donor pallets to the recipient pallets in each negative pick/put transfer are made manually and the control system is arranged to issue instructions to the manual operators by at least one chosen from paper pick slips, voice commands and indicators.

15. A method according to claim 1, wherein the individual transfers of stock units from the donor pallets to the recipient pallets in each negative pick/put transfer are made manually.

16. A method according to claim 1, wherein at least one of the donor or recipient pallets are provided by a conveyor into a work area where each negative pick/put transfer occurs.

17. A method according to claim 16, wherein each conveyor is controlled by a controller that controls movement of the pallets into and/or out of the work area.

18. A method according to claim 1, wherein the selected pallets are required to contain a plurality of stock units and the method further comprises loading at least one further stock unit onto the selected pallets to form a plurality of assembled mixed stock unit pallets.

19. (canceled)

20. (canceled)

21. (canceled)

22. A method according to claim 1 further comprising the steps of:
matching respective ones of the stock orders; and
sequencing the assembly of pallets so that the pallets required to fulfil the stock orders within a respective match are at least partially assembled by a said negative pick/put transfer.

23. (canceled)

24. (canceled)

25. A method of sequencing the assembly of pallets having a plurality of stock units for use in the fulfillment of a batch of stock orders, the orders containing order lines that represent the quantities of individual stock units required in specified pallets to fulfil the batch of orders, the method comprising:
providing a computer that is programmed with a computer program to generate instructions to identify one or more matches of the order lines for a first stock unit where the combined quantity of the first stock unit in each match is equal to a predetermined value or is within a predetermined range; and
sequencing the assembly of pallets utilizing those matches.

26. A method according to claim 25, wherein the predetermined value is equal to the quantity for a full pallet load of the one stock unit or a multiple of that quantity.

27. A method according to claim 26, wherein the predetermined range is ±20% of the predetermined value.

28. A method according to claim 27, further comprising sequencing the assembly of pallets so that the pallets associated with at least one of the matches of order lines are at least partially assembled together.

29. A method according to claim 28, wherein said match assigns a status to each pallet associated with the order lines in that match as being either a donor pallet or a recipient pallet.

30. A method according to claim 29, wherein matches are categorized into different classes, each class representing a match having a unique combination of donor and recipient pallets.

31. A method according to claim 30, further comprising the steps of:
establishing average class efficiency factors for different classes of matches; and
identifying the matches of order lines using the class efficiency factors.

32. A method according to claim 31, further comprising the steps of:
identifying matches of order lines for the first stock unit that fall into a first class; and
subsequently identifying matches within the remaining order lines of the batch of orders that fall into one or more other class that has a lower efficiency factor than the first class.

33. A method according to claim 31, further comprising the steps of:
identifying matches of order lines that fall into one or more classes that have an efficiency factor above a first predetermined level; and
subsequently identifying matches within the remaining order lines that fall into one or more classes that have an efficiency factor above a second predetermined level that is below the first predetermined level.

34. A method according to claim 25, wherein the matching of order lines is made using a recursive algorithm.

35. A method according to claim 25, further comprising the step of:
identifying one or more matches of the order lines for at least one other stock unit where the combined quantity of each other stock unit in each match is equal to a predetermined value or is within a predetermined range; and
sequencing the assembly of pallets utilizing the matches of order lines associated with the first and other stock units.

36. A method according to claim 35, further comprising the steps of:
grouping matches of order lines relating to the first and other stock units which have a common associated pallet;
sequencing the assembly of the pallets so that the pallets in a said group are assembled together.

37. A method according to claim 36, wherein groupings are established using a bandwidth minimisation algorithm.

38. (canceled)

39. (canceled)

40. A method according to claim 25 further comprising:
assembling pallets, whereby associated pallets of each matched order line comprising a said selected subset of pallets and the stock unit of that matched order line being the one stock unit.

41. (canceled)

42. (canceled)

43. A distribution system comprising:
a work area for receiving at any one time;
one or more donor pallets each containing a quantity of a stock unit and one or more recipient pallets arranged to receive stock units; and
a control system operative to control the transfer of stock units from the donor pallets to the recipient pallets in the work area so as to establish desired quantities of the stock units in the donor and recipient pallets for use in the fulfillment of stock orders.

44. A distribution system according to claim 43, further comprising one or more conveyors operative to transport one or both of the donor and recipient pallets into and/or out of the work area.

45. A distribution system according to claim 44, wherein the control system is operative to control movement of the one or more conveyors.

46. A distribution system according to claim 45, wherein the transfer of the stock units in the work area is at least partially conducted manually by operators and the control system is arranged to issue instructions to the operators by at least one chosen from paper pick slips, voice commands and indicators.

47. A distribution system according to claim 45, further comprising automated picking equipment and wherein the transfer of stock units in the work area is at least partially conducted by the automated picking equipment.

48. A distribution system according to claim 47, wherein the control system is arranged to issue instructions to the automated picking equipment to control the transfer of the stock units.

49. A distribution system according to claim 43, wherein the control system identifies the donor and recipient pallets, sequences the movement of the pallets into the work area, and establishes the number of stock units that will be transferred in the work area.

50. A distribution system according to claim 43, wherein the control system is operative to sequence the assembly of pallets in the distribution area by identifying one or more matches of the order lines for a first stock unit where the combined quantity of the first stock unit in each match is equal to a predetermined value or is within a predetermined range; and
sequencing the assembly of pallets utilizing those matches.

51. (canceled)

52. (canceled)

53. (canceled)
